(19) United States
(12) Patent Application Publication
(10) Pub. No.: US 2025/0177100 A1
(43) Pub. Date: Jun. 5, 2025

(54) MOUTHPIECE-TYPE ORAL IMAGING DEVICE USING LENS-LESS CAMERA AND DENTAL DIAGNOSIS AND MANAGEMENT SYSTEM USING SAME

(71) Applicant: AIOBIO CO., LTD., Seoul (KR)

(72) Inventor: Hong-Cheol YOON, Seoul (KR)

(21) Appl. No.: 19/050,370

(22) Filed: Feb. 11, 2025

Related U.S. Application Data
(63) Continuation of application No. PCT/KR2023/018971, filed on Nov. 23, 2023.

(30) Foreign Application Priority Data
Nov. 23, 2023 (KR) 10-2023-0164093
Nov. 23, 2023 (KR) 10-2023-0164094

(51) Int. Cl. A61C 9/00; G06T 7/00

(52) U.S. Cl. CPC A61C 9/004; G06T 7/0012; G06T 2207/30036

(57) ABSTRACT

The present disclosure relates to a mouthpiece-type oral imaging device using a lens-less camera configured to acquire front, rear, and occlusal surface images for each tooth using a mouthpiece provided with lens-less cameras and light sources and at the same time track and analyze successive images according to time series using a pre-trained AI algorithm to detect diagnosis, management, and prediction information so as to improve the precision, reliability, and efficiency of dental diagnosis, treatment, and management, as well as to allow acquisition of images under the same conditions (imaging direction, magnification, location, etc.) for each tooth, regardless of the skill level of a radiographer, thereby further increasing the accuracy and efficiency of diagnosis and treatment, and significantly reducing unnecessary time and manpower consumption due to dental imaging, and a dental diagnosis and management system using the same.

### REFERENCE TO RELATED APPLICATIONS

This is a continuation of International Patent Application PCT/KR2023/018971 filed on Nov. 23, 2023, which designates the United States and claims priority of Korean Patent Application No. 10-2023-0164093 filed on Nov. 23, 2023, and Korean Patent Application No. 10-2023-0164094 filed on Nov. 23, 2023, the entire contents of which are incorporated herein by reference.

### FIELD OF THE INVENTION

The present disclosure relates to a mouthpiece-type oral imaging device using a lens-less camera and a dental diagnosis and management system using the same, and more particularly, to a mouthpiece-type oral imaging device using a lens-less camera configured to acquire front, rear, and occlusal surface images for each tooth using a mouthpiece provided with lens-less cameras and light sources and at the same time track and analyze successive images according to time series using a pre-trained AI algorithm to detect diagnosis, management, and prediction information so as to improve the precision, reliability, and efficiency of dental diagnosis, treatment, and management, as well as to allow acquisition of images under the same conditions (imaging direction, magnification, location, etc.) for each tooth, regardless of the skill level of a radiographer, thereby further increasing the accuracy and efficiency of diagnosis and treatment, and significantly reducing unnecessary time and manpower consumption due to dental imaging, and a dental diagnosis and management system using the same.

### BACKGROUND OF THE INVENTION

In general, an oral disease including dental diseases such as cavities, missing teeth, tartar, plaque, and periodontal disease, which is one of the most widespread diseases in the world, not only causes great pain, but also has a high prevalence, and the longer treatment is delayed, the greater the economic burden, and thus regular diagnosis and management are required.

Accordingly, if treatment and management are carried out through regular monitoring by a treatment institution such as a dentist, various oral diseases can be prevented in the early stages.

In particular, in recent years, as oral treatment technology and equipment have developed, and image analysis and processing technology have become exponentially more sophisticated, a method of diagnosing a patient's oral condition and preventing and treating oral diseases by analyzing teeth images acquired through an intraoral camera is becoming widely available, and images acquired through such an intraoral camera are not only used to identify and diagnose the condition of teeth and periodontium, but are also used as data to explain the condition of teeth to the patient, and used as useful data to check the treatment status before and after treatment or to check the progress of the deterioration of the tooth condition, and after creating a database of teeth and periodontal conditions, they may be used as useful data to check the treatment status before and after treatment or to check the worsening progress of the tooth condition.

However, in the related art, since it is operated in such a manner that the radiographer (therapist) moves the intraoral camera to a location adjacent to a desired tooth or periodontium and then captures images directly, unnecessary time and manpower consumption increase in imaging the entire teeth, patient fatigue also increases, and the quality of the acquired tooth image varies depending on the skill of the radiographer.

In particular, for overall oral diagnosis, images of the front, rear, and occlusal (chewing) surfaces of each tooth are required, so detailed imaging is required, which further increases the problems as described above.

In order to solve the foregoing problems, various studies are being carried out on technology to image a plurality of teeth in a single shot by installing a plurality of cameras on a mouthpiece.

FIG. 1 is a perspective view showing an oral scanner disclosed in Korean Patent No. 10-1942641 (entitled “Mouthpiece-shaped oral scanner”).

An oral scanner 100 (hereinafter, referred to as a first related art) in FIG. 1 includes a body 110 disposed in a curved bar shape to have grooves 111, 112 on upper and lower surfaces thereof, respectively, such that upper teeth can be inserted into the upper groove 111 and lower teeth can be inserted into the lower groove 112, an upper scanner 120 coupled to the upper groove 111 of the body 110 to scan the upper teeth inserted into the upper groove 111, a lower scanner 130 coupled to the lower groove 112 of the body 110 to scan the lower teeth inserted into the lower surface groove 112, a control unit 140 that receives a scan signal from the upper scanner 120 or lower scanner 130 to converts the receive scan signal into data, and a connection unit 15 that transmits data from the controller 140 to the outside.

Here, the upper scanner 120 and the lower scanner 130 have a built-in sensor 101, and a CCD sensor or a CMOS sensor may be applied to the sensor 101.

The related art 100 configured in this manner is manufactured in a mouthpiece shape such that the position of the teeth can be easily confirmed as a patient's mouth shape is scanned while the patient holds it in his or her mouth without opening the mouth, thereby having an advantage of being faster at converting the shape of teeth into data.

However, in the related art, two sensors 101, a lighting source, a circuit board, cables, and the like are provided in a partition wall between the upper groove 111 and the lower groove 112, and in particular, a lens having a predetermined thickness must be provided in the camera sensors 101 such as CCD or CMOS, thereby causing a problem in which the thickness and volume of the partition wall increases.

In addition, an increase in the thickness and volume of the partition wall forms a gap between the patient's upper and lower teeth when the patient's teeth are inserted therein, which reduces the convenience of use because imaging is performed while the patient is unable to close his or her mouth, as well as causes the clarity of the acquired image to deteriorate due to interference of the light source caused by external noise.

Moreover, as in the related art 100, in order to take photos in a narrow area such as the upper groove 111 and the lower groove 112 of the body 110, a lighting source with a sufficient amount of light must be provided, and the lighting source has the characteristic of generating a large amount of heat during the irradiation of light, but the related art 100 does not describe any technology or method for dissipating heat generated from such a lighting source, thereby having a disadvantage of causing safety accidents such as burns when applied to an actual patient.

In general, a person's oral characteristics (teeth size, dentition structure, etc.) have different characteristics for each individual, but the related art 100 does not take these characteristics of teeth into account at all, and the curvature, size, and shape of the upper groove 111 and lower groove 112 into which the patient's teeth are inserted are fixed, and thus, if used by a patient with different oral characteristics, it not only causes tooth damage but also increases the patient's resistance and anxiety, and if the related art 100 is newly manufactured according to the oral characteristics of the patient in order to solve the problem, the manufacturing cost increases excessively.

Meanwhile, in recent years, research has been actively carried out on video analysis technology that performs object detection, type recognition, tracking, and the like using deep learning techniques, and the field of application of video analysis technology using deep learning is increasing exponentially due to an advantage of reducing error rate through learning and increasing the accuracy and precision of the output value,

In particular, deep learning shows tremendous potential in computer vision fields such as classification, object detection, instance segmentation, and image captioning, and with the development of CPU, GPU, and datasets, deep learning-based methodologies are also being actively applied in the medical field.

FIG. 2 is a configuration diagram showing an oral condition remote monitoring system disclosed in Korean Patent No. 10-2074887 (entitled “Oral condition remote monitoring system and method using image analysis”).

The oral condition remote monitoring system (hereinafter, referred to as a second related art) 200 of FIG. 2 may include an oral imaging device 210 capable of imaging an inside of an oral cavity, a user terminal 220 that is wirelessly paired with the oral imaging device 210 to transmit images captured by the oral imaging device 210, an oral condition management server 230 that stores images captured for each subject and the subject's oral condition analysis result data, and an oral condition determination device that receives the captured images from the oral condition management server 230, and detects tartar or plaque through a pre-trained oral condition determination algorithm to display the detected portion of tartar or plaque on the captured images, and transmit an analysis result to the user terminal 220.

The oral condition determination device 250 inputs a plurality of internal images of the oral cavity showing tartar or plaque into the oral condition determination algorithm, and trains the oral condition determination algorithm to determine whether tartar or plaque is present based on a tooth color, a location of occurrence, and a size of the occurrence area.

The second related art 200 configured in this manner may accurately determine whether tartar and plaque are properly removed in real time and at the same time diagnose or monitor tartar and plaque on teeth or gums in the oral cavity, thereby having an advantage of preventing oral periodontal disease in advance, and providing long-term dental care.

However, in the second related art 200, the oral condition determination device 250 is configured to analyze only a single-shot image captured in real time and determine whether tartar or plaque is present based on the tooth color, location of occurrence, and size of the occurrence area, thereby having a disadvantage of lowering the accuracy and precision of diagnosis since the device does not take into account changes in the condition of each tooth according to time series.

In addition, in the second related art 200, the oral condition determination device 250 analyzes a single-shot image to diagnose only a current oral condition and provide the diagnosis result to a user, and thus has structural limitations in that information provided to the user is limited, and various tooth-related information cannot be provided, such as problems and improvement plans for the subject's current dental care, prediction of the oral condition of each tooth, and the like.

### SUMMARY OF THE INVENTION

The present disclosure is intended to solve the foregoing problems, and an aspect of the present disclosure is to provide a mouthpiece-type oral imaging device using a lens-less camera in which the oral imaging device is manufactured as a mouthpiece type that is provided with a plurality of cameras so as to allow acquisition of images under the same conditions (imaging direction, magnification, location, etc.) for each tooth, regardless of the skill level of a radiographer, thereby further increasing the accuracy and efficiency of diagnosis and treatment, and significantly reducing unnecessary time and manpower consumption due to dental imaging.

In order to solve the foregoing problems, a solving means of the present disclosure provides a dental diagnosis and management system, the system including a mouthpiece-type oral imaging device comprising a body inserted into a subject's oral cavity, lens-less cameras provided at intervals on the body to capture at least one of the front, rear, and occlusal surfaces of all teeth, and light sources provided at positions adjacent to the lens-less cameras, respectively, to irradiate light; a medical staff terminal, which is a terminal carried by a medical staff member, provided with a diagnostic service application that digitally filters pattern-data received from the mouthpiece-type oral imaging device to a preset wavelength pass-band, and then performs inverse calculations to acquire an image; and an integrated monitoring/diagnosis server that analyzes images received from the medical staff terminal, detects a diagnostic result including at least one of a condition of each tooth of the subject, a treatment status, and a treatment details, and then generates diagnostic analysis information including the detected diagnostic result to transmit the generated diagnostic analysis information to the medical staff terminal, wherein the diagnostic service application installed on the medical staff terminal displays the diagnostic analysis information received from the integrated monitoring/diagnosis server on a monitor.

Furthermore, in the present disclosure, preferably, the lens-less cameras may each include a mask through which light reflected from an imaging surface of the tooth is transmitted; an image sensor into which light passing through the mask is incident; and a controller that integrates patterns projected onto the image sensor to generate pattern-data, and then transmits the generated pattern-data to the outside, wherein the body is formed of a plate having a length, disposed with a curved surface in such a manner of facing rearward toward both ends thereof, and disposed in parallel to the imaging surface (front, rear, or occlusal surface) of the subject's tooth, and the lens-less cameras slim down the thickness of the mouthpiece-type oral imaging device by replacing the lens with the film-type mask.

Furthermore, in the present disclosure, preferably, the diagnostic service application installed on the medical staff terminal may include an image processing unit, wherein the image processing unit includes a network construction module that checks whether the mouthpiece-type oral imaging device is connected in a wired or wireless manner; a subject setting module that receives identification information of the subject to be imaged from the medical staff (user); a pattern-data input module that receives pattern-data transmitted from the mouthpiece-type oral imaging device; a digital filtering module that filters reflected signals outside the wavelength pass-band of the pattern-data received through the pattern-data input module; an inverse calculation and image acquisition module that inversely calculates the pattern-data filtered by the digital filtering module to convert the inversely calculated pattern-data into a lens-based image; a matching data generation module that generates matching data by matching subject identification information, medical staff identification information, tooth imaging direction (occlusal, front or rear surface) information, lens-less camera identification information, and images; and a control unit that transmits the matching data generated by the matching data generation module to the integrated monitoring/diagnosis server.

Furthermore, in the present disclosure, preferably, the integrated monitoring/diagnosis server may include a DB server; a tooth-image generation unit that analyzes, corrects, and merges images included in the matching data received from the medical staff terminal to generate a tooth-image, which is an image for each tooth; and an AI-based diagnostic analysis unit that analyzes teeth-images of the subject generated by the tooth-image generation unit to generate the diagnostic analysis result, wherein the tooth-image generation unit includes an image sorting module that sorts the images included in the matching data received through the matching data input module in order according to the dentition, with reference to the identification information of the lens-less cameras; an image merging module that merges images sorted in the image sorting module; a tooth object recognition module that recognizes tooth objects, respectively, by analyzing the merged image in the image merging module using a preset object recognition algorithm; an image segmentation module that segments the merged image into images in which the tooth objects recognized by the tooth object recognition module are respectively shown; and a tooth-image generation module that determines the images segmented by the image segmentation module as tooth-images, respectively.

Furthermore, in the present disclosure, preferably, the integrated monitoring/diagnosis server may further include a tooth-data generation/update unit that assigns, if the subject is imaged for the first time, an identification number to a tooth corresponding to a tooth-image generated by the tooth-image generation unit, and then matches at least one of subject identification information, a tooth imaging direction (occlusal, front or rear surface), a tooth identification number and a tooth-image, and an imaging date to generate tooth-data, and then stores the generated tooth-data in the DB server, and extracts, if the subject is not imaged for the first time, the subject's tooth-data from the DB server, and then matches an identification number with a tooth corresponding to a tooth-image generated by the tooth-image generation unit with reference to a tooth identification number of previous tooth-data, and then generates tooth-data, and then stores the generated tooth-data in the DB server.

Furthermore, in the present disclosure, preferably, a category detection algorithm that analyzes the received tooth-image to detect a value (M) for each category (including at least one of caries lesions, cracks, fluorosis, tartar, and plaque) may be stored in the DB server, wherein the integrated monitoring/diagnosis server further includes a category-specific value calculation unit that analyzes tooth-images generated by the tooth-image generation unit using the category detection algorithm to calculate a value (M) for each category of each tooth, matches the subject identification information with values (M) for each category of each tooth to generate category information for each tooth, and then stores the generated category information in the DB server.

Furthermore, in the present disclosure, preferably, a first AI algorithm that uses a current value (M) and a previous value (M′) for each category of each tooth as input data to output a diagnostic result including at least one of a tooth condition, a treatment status, and treatment details may be stored in the DB server, wherein the AI-based diagnostic analysis unit includes a category information collection module for each tooth that collects category information for each tooth calculated by the category-specific value calculation unit and previous category information for each tooth stored in the DB server; a first AI analysis that analyzes a current value (M) and previous values (M′) for each category of each tooth collected from the category information collection module for each tooth using the first AI algorithm to output the diagnosis result; and a diagnostic analysis information generation module that utilizes output data output from the first AI analysis module to generate diagnostic analysis information including the diagnostic result, and then stores the generated diagnostic analysis information in the DB server.

Furthermore, in the present disclosure, preferably, the integrated monitoring/diagnosis server may further include an AI-based management analysis unit; and an AI-based predictive analysis unit, wherein a second AI algorithm that uses a current value (M) and a previous value (M′) for each category of each tooth as input data to output a management result including at least one of a management status, a management method, and a management improvement point, and a third AI algorithm that uses a current value (M) and a previous value (M′) for each category of each tooth as input data to output a prediction result indicating a tooth condition after a preset elapsed time when each tooth is not treated are stored in the DB server, the AI-based management analysis unit analyzes a current value (M) and previous values (M′) for each category of each tooth collected from the category information collection module for each tooth using the second AI algorithm to output the management result, and then generates management analysis information including the output management result, and the AI-based predictive analysis unit analyzes a current value (M) and previous values (M′) for each category of each tooth collected from the category information collection module for each tooth using the third AI algorithm to output the prediction result, and then generates predictive analysis information including the output prediction result.

Furthermore, in the present disclosure, preferably, in the mouthpiece-type oral imaging device, sensor seating grooves that are disposed inward on a mounting surface, which is one surface of the body opposite to an imaging surface of the subject's teeth, and provided with the lens-less cameras may be respectively disposed at intervals in a length direction, and pairs of light source mounting grooves may be disposed at points adjacent to the respective sensor seating grooves on the mounting surface.

Furthermore, in the present disclosure, preferably, the mouthpiece-type oral imaging device may operate in a fluorescence imaging mode, a normal imaging mode, and a mixed imaging mode, wherein the light sources irradiate blue-series visible light having a wavelength of 405 nm in the fluorescence imaging mode, irradiate white visible light in the normal imaging mode, and irradiate blue-series visible light having a wavelength of 405 nm from a half of a total number of the light sources, and irradiate white visible light from the remaining light sources in the mixed imaging mode.

Furthermore, in the present disclosure, preferably, when a mouthpiece-type oral imaging device for imaging the occlusal surfaces of a subject's upper teeth and the occlusal surfaces of the subject's lower teeth is referred to as an occlusal-surface oral imaging device, the body of the occlusal-surface oral imaging device may be disposed horizontally such that an upper surface of the body is in contact with the occlusal surfaces of the subject's upper teeth, a lower surface of the body is in contact with the occlusal surfaces of the subject's lower teeth, and the sensor seating grooves are disposed at intervals in a length direction on the upper and lower surfaces of the body.

Furthermore, in the present disclosure, preferably, the body may be formed of a plate and coupled by at least one hinge shaft, and may include at least two or more sub-bodies constituting the body during the coupling of a hinge, wherein the sensor seating grooves and the light source mounting grooves are disposed on upper and lower surfaces of the sub-bodies, and the hinge shaft is connected to opposing side walls of sub-bodies adjacent thereto, respectively, and installed in a vertical configuration such that the body rotates inward when the sub-bodies are assembled.

Furthermore, in the present disclosure, preferably, the sub-bodies may be arranged in the same number as that of the lens-less cameras in a length direction, wherein single sensor seating grooves are disposed on the upper and lower surfaces of the sub-bodies, respectively.

Furthermore, in the present disclosure, preferably, when a mouthpiece-type oral imaging device for imaging the front surfaces of a subject's upper and lower teeth is referred to as a front-surface oral imaging device, the body of the front-surface oral imaging device may be disposed vertically such that a rear surface of the body faces the front surfaces of the subject's teeth, and the sensor seating grooves are disposed at intervals in a length direction on the rear surface of the body, and arranged in two rows.

Furthermore, in the present disclosure, preferably, the body may be formed of a plate and coupled by at least one hinge shaft, and may include at least two or more sub-bodies constituting the body during the coupling of a hinge, wherein the sensor seating grooves and the light source mounting grooves are disposed on rear surfaces of the sub-bodies, and the hinge shaft is connected to opposing side walls of sub-bodies adjacent thereto, respectively, and installed in a vertical configuration such that the body rotates inward when the sub-bodies are assembled.

Furthermore, in the present disclosure, preferably, the sub-bodies may be arranged in the same number as that of the lens-less cameras in a length direction, wherein pairs of lens-less cameras are provided on rear surfaces of the sub-bodies, respectively, at intervals in a height direction.

Furthermore, in the present disclosure, preferably, when a mouthpiece-type oral imaging device for imaging the rear surfaces of a subject's upper and lower teeth is referred to as a rear-surface oral imaging device, the body of the rear-surface oral imaging device may be disposed vertically such that a front surface of the body faces the rear surfaces of the subject's teeth, and the sensor seating grooves are disposed at intervals in a length direction on the front surface of the body, and arranged in two rows.

Furthermore, in the present disclosure, preferably, the body may be formed of a plate and coupled by at least one hinge shaft, and may include at least two or more sub-bodies constituting the body during the coupling of a hinge, wherein the sensor seating grooves and the light source mounting grooves are disposed on front surfaces of the sub-bodies, and the hinge shaft is connected to opposing side walls of sub-bodies adjacent thereto, respectively, and installed in a vertical configuration such that the body rotates inward when the sub-bodies are assembled.

Furthermore, in the present disclosure, preferably, the sub-bodies may be arranged in the same number as that of the lens-less cameras in a length direction, wherein pairs of lens-less cameras are provided on front surfaces of the sub-bodies, respectively, at intervals in a height direction.

According to the present disclosure having the foregoing problems and solutions, an oral imaging device may be manufactured as a mouthpiece type that is provided with a plurality of cameras so as to allow acquisition of images under the same conditions (imaging direction, magnification, location, etc.) for each tooth, regardless of the skill level of a radiographer, thereby further increasing the accuracy and efficiency of diagnosis and treatment, and significantly reducing unnecessary time and manpower consumption due to dental imaging.

In addition, according to the present disclosure, a diagnostic service application may be configured to perform digital filtering by replacing a conventional physical optical filter while at the same time replacing a camera of a mouthpiece-type oral imaging device with a lens-less camera so as to minimize and slim down the thickness and volume of the oral imaging device, thereby minimizing a subject's foreign body sensation and discomfort, as well as effectively preventing tooth damage and strain.

Furthermore, according to the present disclosure, sufficient imaging may be achieved with a small amount of light by replacing the conventional physical optical filter having a transmittance of approximately 20% with digital filtering to minimize the heat generation of an LED, thereby effectively preventing safety accidents such as burns, and increasing product reliability and safety.

Moreover, according to the present disclosure, an integrated monitoring/diagnosis server may be configured to sort and merge, when receiving images of respective lens-less cameras from the diagnostic service application, them in order according to the dentition, and then recognize tooth objects, respectively, and generate tooth-images by separating the images such that the respective recognized tooth objects are shown, and then analyze the generated tooth-images to detect diagnostic analysis information, thereby improving the accuracy of dental diagnosis and treatment.

Besides, according to the present disclosure, the integrated monitoring/diagnosis server may analyze each tooth-image to calculate a preset value (M) for each category, and at the same time analyze a current value (M) and previous values (M′) for each category of each tooth using a pre-trained first AI algorithm to detect diagnostic analysis information so as to allow accurate and detailed diagnosis, thereby significantly increasing treatment effectiveness and efficiency.

### BRIEF DESCRIPTION OF THE DRAWINGS

FIG. 1 is a perspective view showing an oral scanner disclosed in Korean Patent No. 10-1942641 (entitled “Mouthpiece-shaped oral scanner”).

FIG. 2 is a configuration diagram showing an oral condition remote monitoring system disclosed in Korean Patent No. 10-2074887 (entitled “Oral condition remote monitoring system and method using image analysis”).

FIG. 3 is a configuration diagram showing a dental diagnosis and management system according to an embodiment of the present disclosure.

FIG. 4 is a conceptual diagram for explaining FIG. 3.

FIG. 5 is a perspective view showing an occlusal-surface oral imaging device, which is an embodiment of a mouthpiece-type oral imaging device in FIG. 3.

FIG. 6 is a conceptual diagram for explaining FIG. 5.

(a) of FIG. 7 is a photograph when a tooth is normally imaged, and (b) of FIG. 7 is a photograph when blue visible light is irradiated to the tooth and then blue-series light is filtered.

FIG. 8 is a conceptual diagram showing a lens-less camera in FIG. 5.

(a) of FIG. 9 is an exemplary diagram for explaining a phase mask-based lens-less imaging method of the present disclosure, and (b) of FIG. 9 is an exemplary diagram for explaining a lens-based imaging method.

FIG. 10 is a perspective view showing a rear-surface oral imaging device, which is a second embodiment of the mouthpiece-type oral imaging device of the present disclosure.

FIG. 11 is a perspective view showing a front-surface oral imaging device, which is a third embodiment of the mouthpiece-type oral imaging device of the present disclosure.

FIG. 12 is a perspective view showing a second embodiment of the occlusal-surface oral imaging device of FIG. 5.

FIG. 13 is a perspective view showing a second embodiment of a rear-surface oral imaging device of FIG. 10.

FIG. 14 is a perspective view showing a second embodiment of the front-surface oral imaging device of FIG. 11.

FIG. 15 is a perspective view showing a third embodiment of the occlusal-surface oral imaging device of FIG. 5.

FIG. 16 is a perspective view showing a third embodiment of a rear-surface oral imaging device of FIG. 10.

FIG. 17 is a perspective view showing a third embodiment of a front-surface oral imaging device of FIG. 11.

FIG. 18 is a block diagram showing a diagnostic service application in FIG. 3.

FIG. 19 is an exemplary diagram showing a selection interface provided by an operation-mode selection unit in FIG. 18.

FIG. 20 is a block diagram showing an image processing unit in FIG. 17.

FIG. 21 is a block diagram showing a medical staff-mode operation unit in FIG. 18.

FIG. 22 is a block diagram showing an integrated monitoring/diagnosis server in FIG. 3.

FIG. 23 is a block diagram showing a tooth-image generation unit in FIG. 22.

FIG. 24 is a block diagram showing an AI-based diagnostic analysis unit in FIG. 22.

FIG. 25 is a block diagram showing an AI-based management analysis unit in FIG. 22.

FIG. 26 is a block diagram showing an AI-based predictive analysis unit in FIG. 22

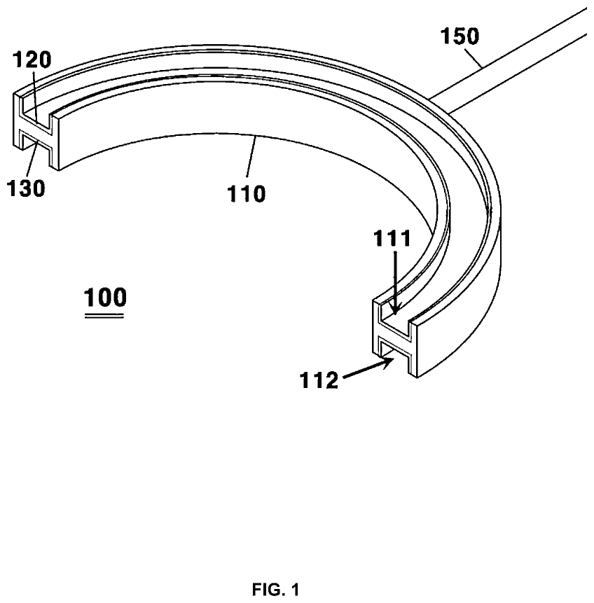

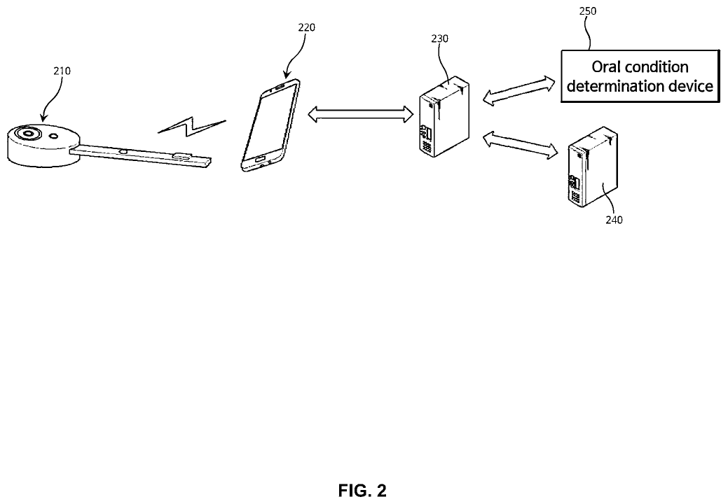

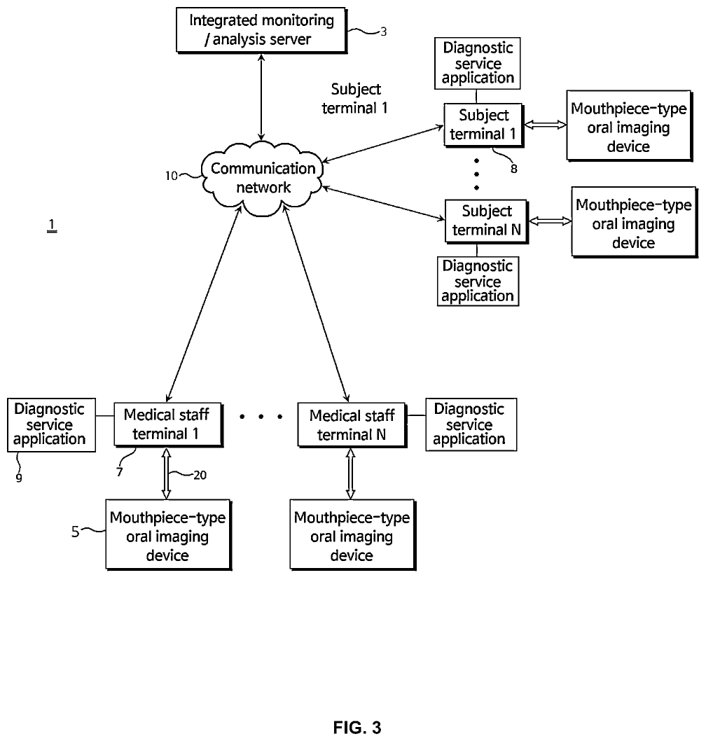

### DETAILED DESCRIPTION OF THE INVENTION

Hereinafter, an embodiment of the present disclosure will be described with reference to the accompanying drawings.

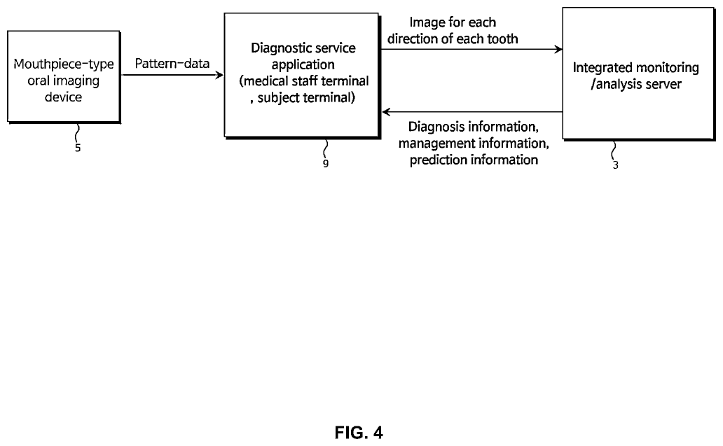

FIG. 3 is a configuration diagram showing a dental diagnosis and management system according to an embodiment of the present disclosure, and FIG. 4 is a conceptual diagram for explaining FIG. 3.

A dental diagnosis and management system 1, which is an embodiment of the present disclosure in FIGS. 3 and 4 is configured to acquire front, rear, and occlusal surface images for each tooth using a mouthpiece provided with lens-less cameras and light sources and at the same time track and analyze successive images according to time series using a pre-trained AI algorithm to detect diagnosis, management, and prediction information so as to improve the precision, reliability, and efficiency of dental diagnosis, treatment, and management, as well as to allow acquisition of images under the same conditions (imaging direction, magnification, location, etc.) for each tooth, regardless of the skill level of a radiographer, thereby further increasing the accuracy and efficiency of diagnosis and treatment, and significantly reducing unnecessary time and manpower consumption due to dental imaging.

In addition, as shown in FIGS. 3 and 4, the dental diagnosis and management system 1 of the present disclosure includes an integrated monitoring/analysis server 3, mouthpiece-type oral imaging devices 5, a medical staff terminal 7, a user terminal 8, a diagnostic service application 9, and a communication network 10.

Here, in the present disclosure, for the sake of convenience of explanation, for example, it has been described that the diagnostic service application 9 acquires images by inversely calculating pattern-data received from lens-less cameras, and the integrated monitoring/analysis server 3 analyzes the acquired images, and then generates meaningful information (tooth diagnosis, management, prediction, etc.), but the computational processing of image analysis and meaningful information generation may be configured to be autonomously performed by the diagnostic service application 9.

In addition, in the present disclosure, for the sake of convenience of explanation, for example, it has been described that the diagnostic service application 9 is installed in the medical staff terminal 7 and the subject terminal 8, respectively, but it may also be configured such that different dedicated applications are installed in the medical staff terminal 7 and the subject terminal 8.

The communication network 10 provides a data movement path among the integrated monitoring/diagnosis server 3, the medical staff terminal 7, and the subject terminal 8, and specifically, may be configured with wired and wireless networks such as a wide area network (WAN), a local area network (LAN), and the like, a mobile communication network, 3G, LTE, 4G, or the like.

The medical staff terminal 7 is a digital terminal owned by a medical staff member (doctor, nurse, therapist, etc.), the subject terminal 8 is a digital terminal owned by a subject (user), and the medical staff terminal 7 and the subject terminal 8 may be configured with a desktop PC, a laptop, a smart phone, a tablet PC, and the like.

In addition, the medical staff terminal 7 and the subject terminal 8 are connected to the mouthpiece-type oral imaging device 5 through a wired/wireless communication network 20 to receive pattern-data acquired through imaging by the mouthpiece-type oral imaging device 5 from the mouthpiece-type oral imaging device 5.

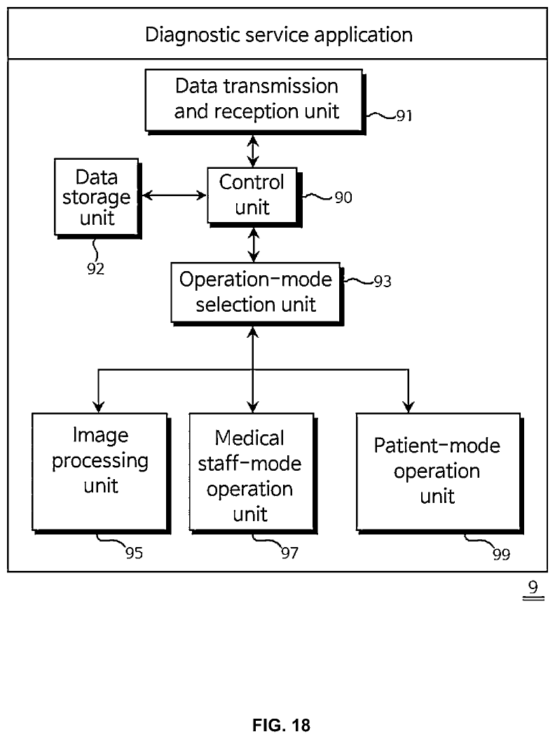

In addition, the diagnostic service application 9 of FIG. 18, which will be described later, is installed on the medical staff terminal 7 and the subject terminal 8.

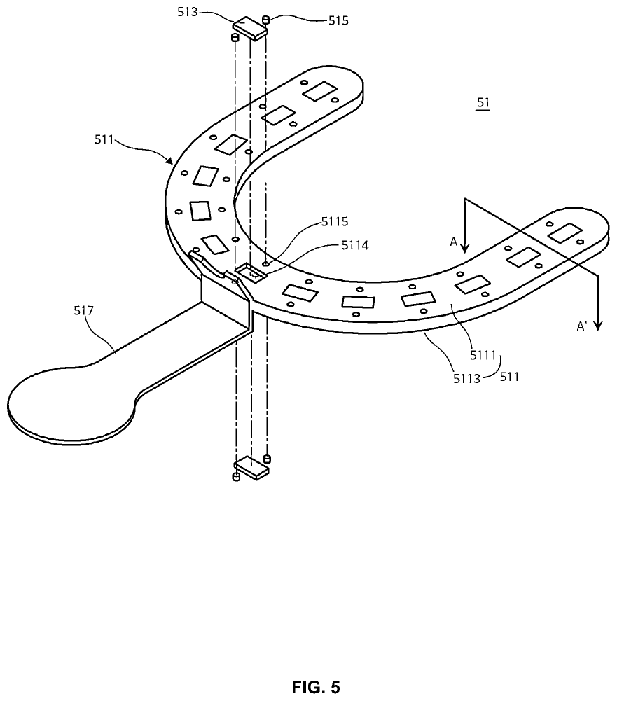

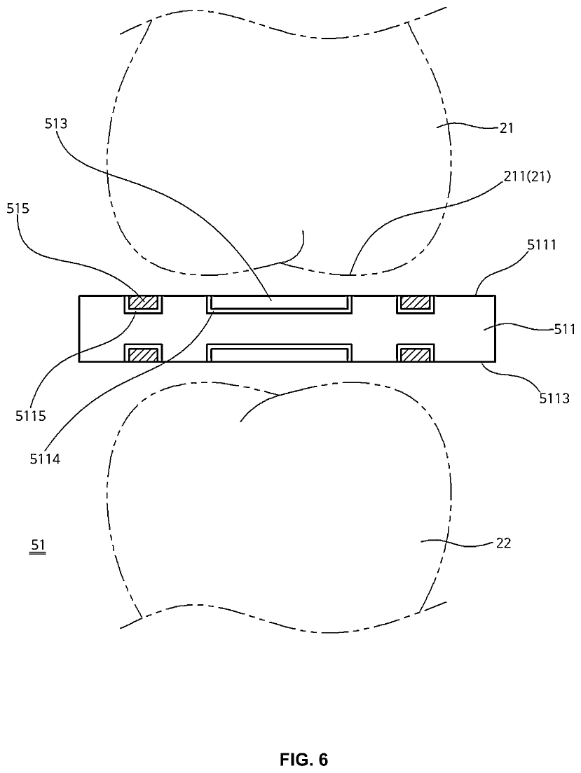

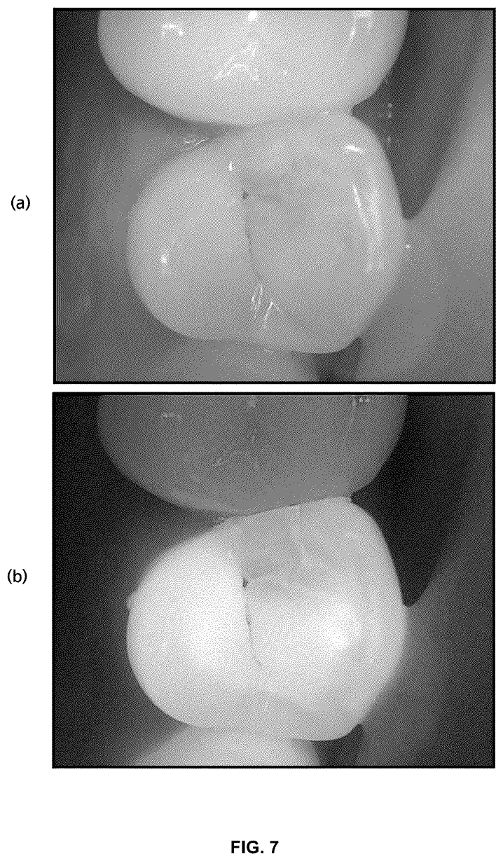

FIG. 5 is a perspective view showing an occlusal-surface oral imaging device, which is an embodiment of a mouthpiece-type oral imaging device in FIG. 3, and FIG. 6 is a conceptual diagram for explaining FIG. 5.

FIGS. 5 and 6 show an occlusal-surface oral imaging device 51, which is an embodiment of the mouthpiece-type oral imaging device 5, and the occlusal-surface oral imaging device 51 is a device of imaging, by lens-less cameras 513 arranged in a row along the subject's dentition, when inserted into the subject's oral cavity to be bitten by the subject's teeth, upper and lower occlusal surfaces (chewing surfaces) of the respective teeth to acquire pattern-data for the respective occlusal surfaces.

In addition, as shown in FIG. 6, the occlusal-surface oral imaging device 51 includes a body 511 disposed in a mouthpiece shape to be inserted into the subject's oral cavity, and disposed with an upper surface 5111 and a lower surface 5113 having a flat surface to be pressed by a subject's upper and lower occlusal surfaces 211, lens-less cameras 513 provided on the upper surface 5111 and the lower surface 5113 of the body 511, and provided at intervals in a length direction, light sources 515 provided to face each other in a width direction with respect to each lens-less camera 513, but provided at intervals in the length direction, a controller (not shown) that supplies power to the lens-less cameras 513 and the light sources 515 and at the same time transmits pattern-data acquired through the imaging of the lens-less cameras 513 to the connected terminal 7 or 8.

The body 511 is disposed in a mouthpiece shape, and the upper surface 5111 and the lower surface 5113 are disposed to be flat, thereby allowing the occlusal surfaces 211 of the subject's upper teeth 21 to come into the upper surface 5111, and allowing the occlusal surfaces of the subject's lower teeth 22 to come into contact with the lower surface 5113.

Here, the body 511 is preferably made of a material that is harmless to a human body to minimize a subject's foreign body sensation and discomfort when bitten by the subject, and at the same time, made of a synthetic resin material with high elasticity and flexibility so as not to put any strain on the teeth.

Additionally, the body 511 is manufactured in a shape that corresponds to a shape of the teeth, dentition, and oral cavity of a human body.

In addition, sensor seating grooves 5114 are disposed on the upper surface 5111 and lower surface 5113 of the body 511 at intervals in a length direction inwardly from the upper surface 5111 and lower surface 5113.

Here, the lens-less cameras 513 may be provided in the sensor seating grooves 5114 of the body 511, thereby allowing the lens-less cameras 513 to be arranged in a row in a length direction along the occlusal surfaces of the upper and lower teeth so as to image the upper and lower occlusal surfaces of the respective teeth.

Additionally, the light source mounting grooves 5115 are disposed symmetrically in a width direction with respect to the sensor seating groove 5114 of the body 511.

Here, light sources 515 are provided in the light source mounting grooves 5115, respectively.

Additionally, a handle 517 that is gripped by a hand of a medical staff member or user is disposed to protrude from a front side of the body 511.

In addition, although not shown in the drawing, a heating means and a cooling means may be provided inside a point adjacent to the light source mounting groove 5115 of the body 511 in the occlusal-surface oral imaging device 51, and at this time, the controller operates, when a control signal for the heating or cooling means in a specific area is received from an external computing device, the heating or cooling means of the corresponding area so as to test a degree of sensitivity or reaction of the subject's specific tooth to heat or cold.

The light sources 515 are respectively provided in the light source mounting grooves 5115 disposed on the upper surface 5111 and the lower surface 5113 of the body 511 to irradiate LED light toward the occlusal surfaces of the corresponding teeth, thereby providing lighting necessary for imaging with the lens-less cameras 513.

That is, among the light sources 515, a pair of light sources 515 provided symmetrically in a width direction with respect to the lens-less camera 513 radiates LED light toward the occlusal surface of the corresponding tooth.

Additionally, the light sources 515 irradiate blue-series visible light, that is, visible light having a wavelength of 405 nm.

Meanwhile, the mouthpiece-type oral imaging device 5 of the present disclosure is designed to support all of a fluorescence (blue light) imaging mode, a normal imaging mode, and a mixed imaging mode, and when any one of the fluorescence imaging mode, the normal imaging mode, and the mixed imaging mode is selected by a radiographer, light is irradiated from the light sources 515 according to the selected mode.

As an example, the mouthpiece-type oral imaging device 5 irradiates blue visible light having a wavelength of 405 nm from the light sources 515 when the fluorescence imaging mode is selected by the radiographer, and irradiates white visible light from the light sources 515 when the normal imaging mode is selected.

(a) of FIG. 7 is a general photograph of imaging a tooth, and (b) of FIG. 7 is a tooth photograph when blue visible light is irradiated, and then a wavelength band of blue visible light is filtered.

In general, blue-series visible light not only does not pass through a tooth but also has the property of causing fluorescence when reflected. Meanwhile, when the tooth loses minerals, its fluorescence intensity appears darker than that of a normal tooth, and specifically, caries lesions, crack, fluorosis, tartar, plaque, and the like on the tooth surface have the characteristic of appearing dark. Meanwhile, porphyrin that generates a biofilm has the property of causing red fluorescence.

That is, when blue visible light is irradiated, and then the reflected light of blue visible light irradiated from an external computing device is digitally filtered, as shown in (a) and (b) of FIG. 4, a porphyrin component that generates a biofilm is highlighted in red through color contrast, and caries lesions, cracks, fluorosis, tartar, and plaque on the tooth surface may be easily identified depending on a difference in brightness of the reflected light.

Meanwhile, since a conventional physical optical filter has a transmittance of approximately 20%, an irradiation amount of the light source is unnecessarily high in order to irradiate a sufficient amount of light for imaging, and such an increase in the amount of light of the light source also increases an amount of heat generated, but special caution is required because the increased amount of heat generated in the mouthpiece-type product may cause safety accidents such as burns.

Accordingly, the mouthpiece-type oral imaging device 5 of the present disclosure may achieve sufficient imaging with a small amount of light by not installing a conventional optical filter, thereby reducing the amount of LED heat generated to improve the reliability and safety of the product, as well as minimizing and slimming down the thickness and volume of the product itself to increase the wearing comfort of the subject.

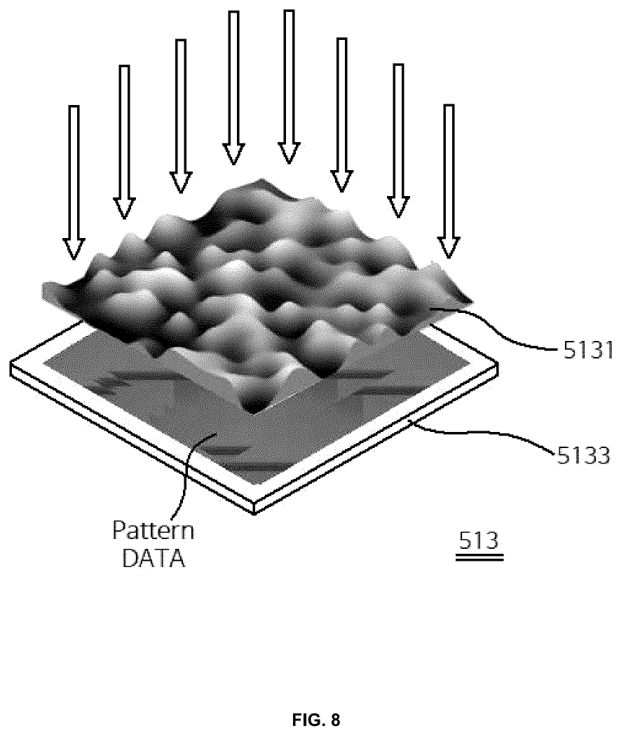

FIG. 8 is a conceptual diagram showing a lens-less camera in FIG. 5, and (a) of FIG. 9 is an exemplary diagram for explaining a phase mask-based lens-less imaging method of the present disclosure, and (b) of FIG. 9 is an exemplary diagram for explaining a lens-based imaging method.

The lens-less cameras 513 are mounted in the sensor seating grooves 5114 disposed on the upper surface 5111 and the lower surface 5113 of the body 511, respectively, and thus provided at intervals in a width direction along the subject's dentition when inserted into his or her oral cavity.

Here, the lens-less cameras 513 provided on a top of the body 511 respectively image the occlusal surfaces 211 of the subject's upper teeth 21, and the lens-less cameras 513 provided on a bottom of the body 511 respectively image the occlusal surfaces of the subject's lower teeth 22.

In addition, as shown in FIG. 8, the lens-less camera 513 includes a phase mask 5131 through which light irradiated and reflected from the light sources 515 is transmitted, and an image sensor 5133 into which light passing through the phase mask 5131 is incident.

Here, in the present disclosure, for the sake of convenience of explanation, for example, it has been described that the mask of the lens-less camera 513 is a phase mask, but the mask of the lens-less camera 513 is not limited thereto, and any mask based on various known types and technologies, such as an amplitude mask, may of course be applied thereto.

That is, a phase mask 5131 that changes a phase of light through a pattern having fine projections, in replacement of a lens that focuses a point light source, is applied to the lens-less camera 513.

The phase mask 5131 is made of a transparent material that transmits light, such as a transparent film.

In addition, the phase mask 5131 has a fine projection pattern having an irregular form in size, height, shape, and the like, for each position on an outer surface thereof in a direction opposite to the image sensor 515.

Here, the phase mask 5131 changes and diffuses the phase by delaying the transmitted light differently for each position to a pattern according to a point spread function (PSF), which represents a unique pattern determined according to the shape structure.

That is, the phase of a point light source passing through the phase mask 5131 is converted and diffused according to a phase conversion pattern to be incident on an entire area of the image sensor 5133.

The image sensor 5133 receives a pattern whose phase has changed by passing through the phase mask 5131.

Here, patterns projected onto the image sensor 5133 will be integrally referred to as pattern-data.

In addition, the pattern-data acquired by the image sensor 5133 is transmitted to the medical staff terminal 7 or the subject terminal 8 under the control of the controller (not shown), and the diagnostic service application 9 installed on the terminal digitally filters, when receiving pattern-data, the transmitted pattern-data and then performs inverse calculations to acquire an image.

Referring to (b) of FIG. 9, when comparing the lens-less camera 513 of the present disclosure with a conventional lens camera, in the lens-less camera 513 of the present disclosure, as shown in (a) of FIG. 9, when light irradiated from the light source 515 and reflected on the tooth passes through the phase mask 5131, the phase of a point light source is converted and diffused by a fine projection pattern of the phase mask 5131 and projected onto the image sensor 5133 spaced apart by a focal distance f.

In addition, in the conventional lens camera 513, as shown in (a) of FIG. 9, at least one lens 1011 is disposed in front of the image sensor 1012 such that a point light source passes through the lens 1011, and then is incident onto the image sensor 1012 in the form of a point, thereby acquiring an image.

In general, in the case of a mouthpiece-type product inserted into a subject's oral cavity, such as the mouthpiece-type oral imaging device 5 of the present disclosure, the most sensitive issue for the subject is whether he or she feels a foreign body sensation, a feeling of wearing, and discomfort when the mouthpiece-type product is bitten by his or her teeth. In particular, since the mouthpiece is bitten by the subject's upper and lower teeth, the thicker the area bitten by the upper and lower teeth, the greater the subject's foreign body sensation and discomfort, and the significantly reduced wearing comfort.

In consideration of the characteristics of such a mouthpiece-type product, according to the present disclosure, a lens-less camera may be provided therein instead of a conventional lens camera to minimize an overall volume and thickness thereof, thereby minimizing the thickness even when a plurality of lens-less cameras are provided therein.

Meanwhile, in the related art, an optical filter that filters light having a specific wavelength is disposed to be spaced apart from an outside of a lens camera to implement a quantitative light-induced fluorescence (QLF) (registered trademark) technique, but the physical installation of such an optical filter increases the thickness of a mouthpiece-type product and at the same time requires an increase in the amount of light due to the light transmittance of approximately 20%, so the amount of heat generated also increases, and thus, when applied to a mouthpiece-type product as in the present disclosure, there is a problem of causing safety accidents such as burns.

Accordingly, in the present disclosure, in replacement of a conventional physical optical filter, the diagnostic service application 9 is configured to perform digital filtering, thereby manufacturing the mouthpiece-type oral imaging device 5 in a slimmer and more compact manner while at the same time effectively preventing safety accidents.

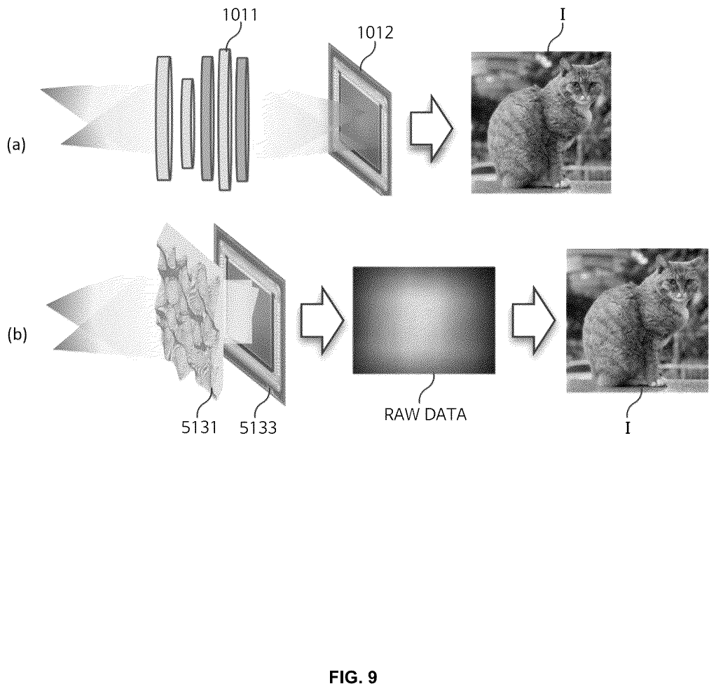

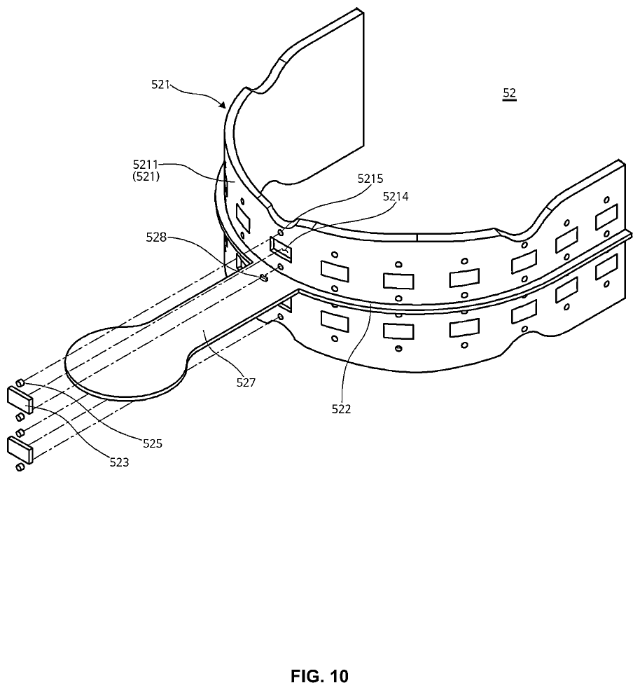

FIG. 10 is a perspective view showing a rear-surface oral imaging device, which is a second embodiment of the mouthpiece-type oral imaging device of the present disclosure.

A rear-surface oral imaging device 52 of FIG. 10, which is a second embodiment of the mouthpiece-type oral imaging device 5 of the present disclosure, is a device of imaging, by lens-less cameras 523 arranged in a row along the subject's dentition, when inserted into the subject's oral cavity to be bitten by the subject's teeth, rear surfaces of the respective teeth to acquire pattern-data for the rear surfaces of the respective teeth.

In addition, as shown in FIG. 10, the rear-surface oral imaging device 52 includes a second body 521 formed of a plate having a length, provided in perpendicular to an oral insertion direction, and rounded to face rearward from the midpoint in a length direction toward both ends thereof, a seating portion 522 protruding from the midpoint in a height direction on a front surface 5211 of the second body 521 and extending along the length, lens-less cameras 523 provided on the front surface 5211 of the second body 522 at intervals in the height direction and at intervals in the length direction, light sources 525 provided to face each other with respect to each lens-less camera 523 in the height direction, and a controller (not shown) that supplies power to the lens-less cameras 523 and the light sources 525 and at the same time transmits pattern-data acquired through the imaging of the lens-less cameras 523 to the connected terminal 7 or 8.

The second body 521 is formed of a plate having a length, is disposed in a direction perpendicular to the oral insertion direction, and is rounded to face rearward from the midpoint in a length direction toward both ends thereof.

Here, the second body 521 is preferably manufactured in a shape that corresponds to the shape of the subject's dentition.

In addition, when the second body 521 is inserted into the subject's oral cavity, the front surface thereof may be disposed at a predetermined distance from the rear surfaces of the subject's teeth, thereby allowing the lens-less cameras 523 provided on the front surface of the second body 521 to image the rear surfaces of the respective teeth of the subject.

Additionally, at the midpoint of the front surface 5211 of the second body 521 in a height direction, a seating portion 522 protruding outward from the front surface 5211 is disposed to extend in a length direction.

In addition, on the front surface 5211 of the second body 521, second sensor seating grooves 5214 are disposed to face each other in the height direction and are spaced apart in a length direction, and the second sensor seating grooves 5214 are respectively provided with the lens-less cameras 523.

In addition, light source mounting grooves 5215 provided with the light sources 525 are disposed at upper and lower portions of the second sensor seating grooves 5214, respectively, on the front surface 5211 of the second body 521.

Additionally, a handle 527 that is gripped by a hand of a medical staff member or user is disposed to protrude from a forefront surface of the second body 521.

In addition, a guide protrusion 528 for guiding a reference position by being in contact with the subject's upper front teeth is disposed to protrude on an upper surface adjacent to the second body 521 of the handle 527.

The rear-surface oral imaging device 52 configured in this manner may be configured such that the second body 521 is disposed at a predetermined distance behind the dentition when inserted into the subject's oral cavity, and at the same time, the lens-less cameras 523 are provided on a front surface of the second body 521 at intervals in length and height directions so as to acquire pattern-data by imaging the rear surfaces of the subject's teeth (including upper teeth and lower teeth) through imaging by the respective lens-less cameras 523, thereby allowing the detailed analysis, diagnosis, and treatment of the rear surfaces of the subject's teeth.

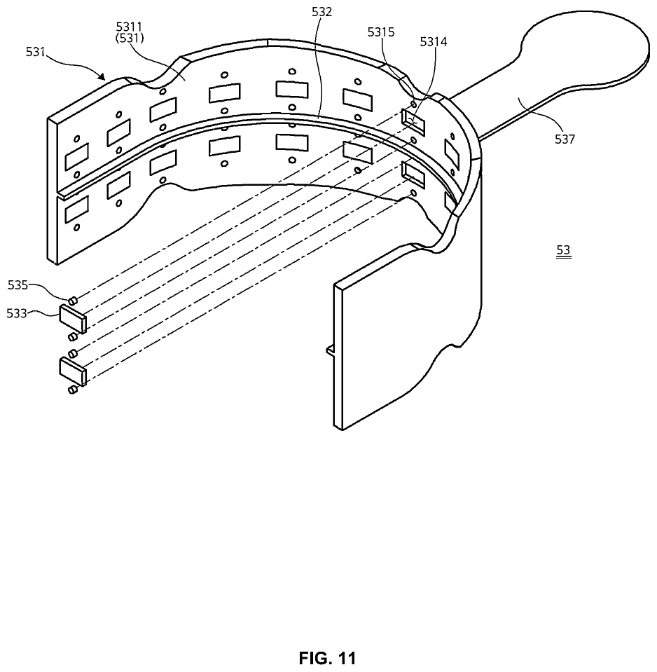

FIG. 11 is a perspective view showing a front-surface oral imaging device, which is a third embodiment of the mouthpiece-type oral imaging device of the present disclosure.

A front-surface oral imaging device 53 of FIG. 11, which is a third embodiment of the mouthpiece-type oral imaging device 5 of the present disclosure, is a device of imaging, by lens-less cameras 533 arranged in a row along the subject's dentition, when inserted into the subject's oral cavity to be bitten by the subject's teeth, front surfaces of the respective teeth to acquire pattern-data for the front surfaces of the respective teeth.

In addition, as shown in FIG. 11, the front-surface oral imaging device 53 includes a third body 531 formed of a plate having a length, provided in perpendicular to an oral insertion direction, and rounded to face rearward from the midpoint in a length direction toward both ends thereof, a third seating portion 532 protruding from the midpoint in a height direction on a rear surface 5311 of the third body 531 and extending along the length to be bitten by the subject's upper and lower teeth, lens-less cameras 533 provided on the rear surface 5311 of the third body 531 at intervals in the height direction and at intervals in the length direction, light sources 535 provided to face each other with respect to each lens-less camera 533 in the height direction, and a controller (not shown) that supplies power to the lens-less cameras 533 and the light sources 535 and at the same time transmits pattern-data acquired through the imaging of the lens-less cameras 533 to the connected terminal 7 or 8.

The third body 531 is formed of a plate having a length, is disposed in a direction perpendicular to the oral insertion direction, and is rounded to face rearward from the midpoint in a length direction toward both ends thereof.

Here, the third body 531 is preferably manufactured in a shape that corresponds to the shape of the subject's dentition.

In addition, when the third body 531 is inserted into the subject's oral cavity, the rear surface 5311 may be disposed at a predetermined distance from the front surfaces of the subject's teeth, thereby allowing the lens-less cameras 533 provided on the rear surface of the third body 531 to image the rear surfaces of the respective teeth of the subject.

Additionally, at the midpoint of the rear surface 5311 of the third body 531 in a height direction, the third seating portion 532 protruding outward from the rear surface 5311 is disposed to extend in a length direction.

Here, when the third body 531 is inserted into the subject's oral cavity, the subject's upper and lower teeth come into contact with the upper and lower surfaces of the third seating portion 532.

In addition, on the rear surface 5311 of the third body 531, third sensor seating grooves 5314 are disposed to face each other in the height direction and are spaced apart in a length direction, and the third sensor seating grooves 5314 are respectively provided with the lens-less cameras 533.

In addition, light source mounting grooves 5315 provided with the light sources 535 are disposed at upper and lower portions of the third sensor seating grooves 5314, respectively, on the rear surface 5311 of the third body 531.

Additionally, a handle 537 that is gripped by a hand of a medical staff member or user is disposed to protrude from a forefront surface of the third body 521.

The front-surface oral imaging device 53 configured in this manner may be configured such that the third body 531 is disposed at a predetermined distance in front of the subject's dentition when inserted into the subject's oral cavity, and at the same time, the lens-less cameras 533 are provided on a rear surface of the third body 531 at intervals in length and height directions so as to acquire pattern-data by imaging the front surfaces of the subject's teeth (including upper teeth and lower teeth) through imaging by the respective lens-less cameras 533, thereby allowing the detailed analysis, diagnosis, and treatment of the rear surfaces of the subject's teeth.

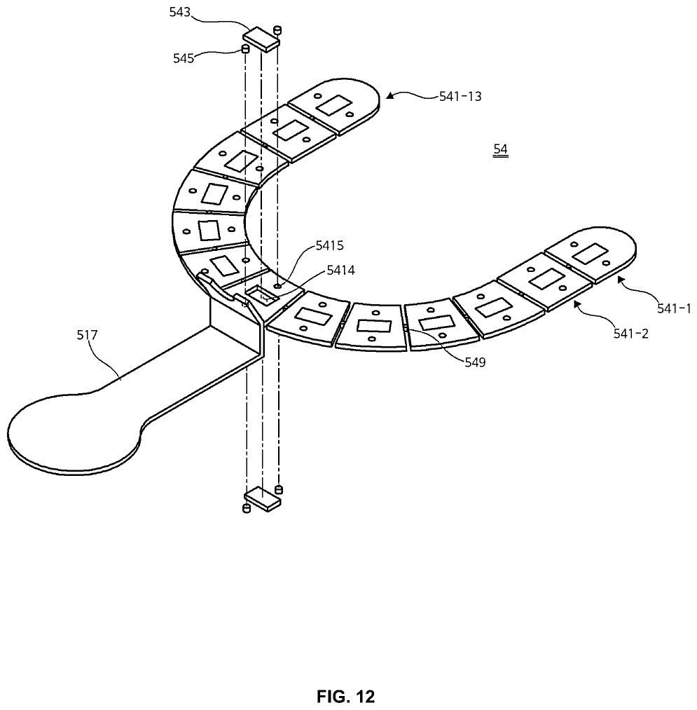

FIG. 12 is a perspective view showing a second embodiment of the occlusal-surface oral imaging device of FIG. 5.

The second occlusal-surface oral imaging device 54 of FIG. 12, which is a second embodiment of the occlusal-surface oral imaging device 52 of FIG. 5 as described above, may be configured such that sub-bodies 541-1, . . . , 541-N are coupled to hinges 549 by taking into account that oral characteristics such as a number of teeth, a dentition shape, and an oral structure are different for each human body, thereby rotating the sub-bodies in response to the subject's various oral characteristics so as to allow interlocking and application to various oral characteristics.

In addition, as shown in FIG. 12, the second occlusal-surface oral imaging device 54 includes a fourth body 541 in which a plurality of sub-bodies 541-1, . . . , 541-N are coupled to the hinges 549 to constitute a mouthpiece shape, lens-less cameras 543 provided on upper and rear surfaces of the sub-bodies 541-1, . . . , 541-N, respectively, and light sources 545 provided on front and rear surfaces of the respective sub-bodies 541-1, . . . 541-N.

The sub-bodies 541-1, . . . , 541-N may be formed of a flat plate, and adjacent sub-bodies and side surfaces thereof may be coupled to the hinges 549 to be assembled into a mouthpiece shape so as to rotate the respective sub-bodies 541-1, . . . , 541-N in response to the subject's oral characteristics (a number of teeth, a dentition shape, an oral structure, etc.), thereby improving the subject's foreign body sensation and discomfort, as well as effectively preventing damage to the subject's teeth.

That is, the sub-bodies 541-1, . . . , 541-N are coupled to one another in a joint manner.

In addition, fourth sensor seating grooves 5414 are disposed on front and rear surfaces of the sub-bodies 541-1, . . . , 541-N, respectively, and light source seating grooves 5415 are disposed respectively on the upper and lower portions of the respective sensor seating groove 5414.

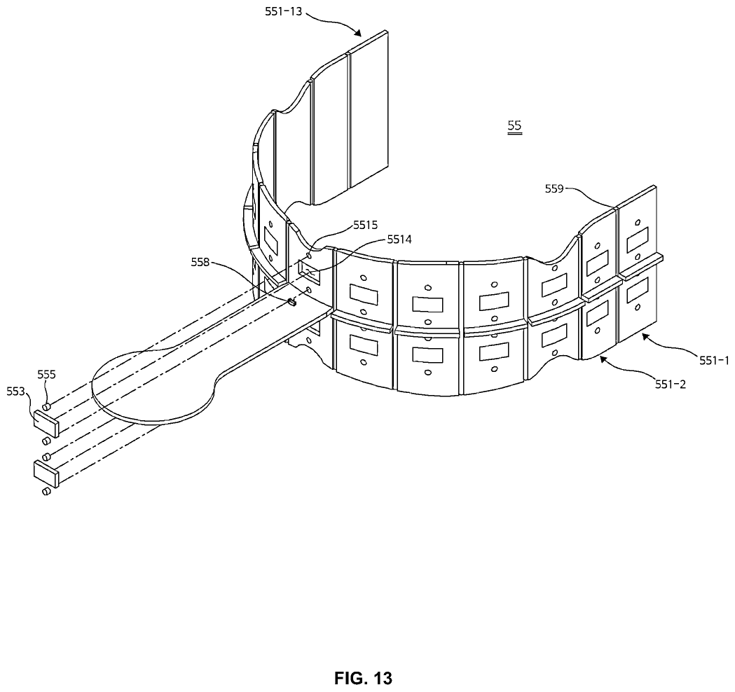

FIG. 13 is a perspective view showing a second embodiment of a rear-surface oral imaging device of FIG. 10.

The second rear-surface oral imaging device 55 of FIG. 13 is a second embodiment of the rear-surface oral imaging device 51 of FIG. 10 as described above.

In addition, as shown in FIG. 13, the second rear-surface oral imaging device 55 includes a fifth body 551 in which a plurality of second sub-bodies 551-1, . . . , 551-N are coupled to hinges 559 to constitute a mouthpiece shape, lens-less cameras 553 provided at intervals in a height direction on front surfaces of the second sub-bodies 551-1, . . . , 551-N, respectively, and light sources 555 provided on front surfaces of the respective second sub-bodies 551-1, . . . , 551-N.

The second sub-bodies 551-1, . . . , 551-N are formed of a flat plate to be disposed vertically when inserted into the oral cavity, and adjacent sub-bodies and side surfaces thereof are coupled to the hinges 559 to be assembled into a mouthpiece shape.

That is, the second sub-bodies 551-1, . . . , 551-N may be configured such that the side surfaces of the adjacent second sub-bodies are coupled to the hinges 559 to rotate at a predetermined angle, thereby allowing them to flexibly respond to the oral characteristics of the subject.

That is, the second sub-bodies 551-1, . . . , 551-N are coupled to one another in a joint manner.

In addition, seating grooves 5514 are disposed on front and rear surfaces of the second sub-bodies 551-1, . . . , 551-N, respectively, and light source seating grooves 5415 are disposed respectively on the upper and lower portions of the respective sensor seating groove 5514.

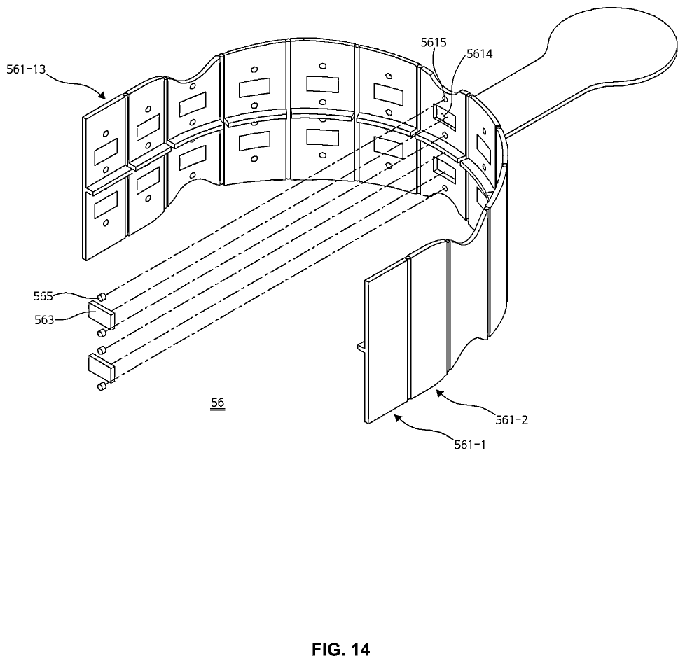

FIG. 14 is a perspective view showing a second embodiment of the front-surface oral imaging device of FIG. 11.

The second front-surface oral imaging device 56 of FIG. 14 is a second embodiment of the front-surface oral imaging device 53 of FIG. 11 as described above.

In addition, as shown in FIG. 14, the second rear-surface oral imaging device 56 includes a sixth body 561 in which a plurality of third sub-bodies 561-1, . . . , 561-N are coupled to hinges 569 to constitute a mouthpiece shape, lens-less cameras 563 provided at intervals in a height direction on rear surfaces of the third sub-bodies 561-1, . . . , 561-N, respectively, and light sources 565 provided on front surfaces of the respective third sub-bodies 561-1, . . . 561-N.

The third sub-bodies 561-1, . . . , 561-N are formed of a flat plate to be disposed vertically when inserted into the oral cavity, and adjacent sub-bodies and side surfaces thereof are coupled to the hinges 569 to be assembled into a mouthpiece shape.

That is, the third sub-bodies 561-1, . . . , 561-N may be configured such that the side surfaces of the adjacent third sub-bodies are coupled to the hinges 569 to rotate at a predetermined angle, thereby allowing them to flexibly respond to the oral characteristics of the subject.

That is, the third sub-bodies 561-1, . . . , 561-N are coupled to one another in a joint manner.

In addition, seating grooves 5614 are disposed on front and rear surfaces of the third sub-bodies 561-1, . . . , 561-N, respectively, and light source seating grooves 5615 are disposed respectively on the upper and lower portions of the respective sensor seating groove 5614.

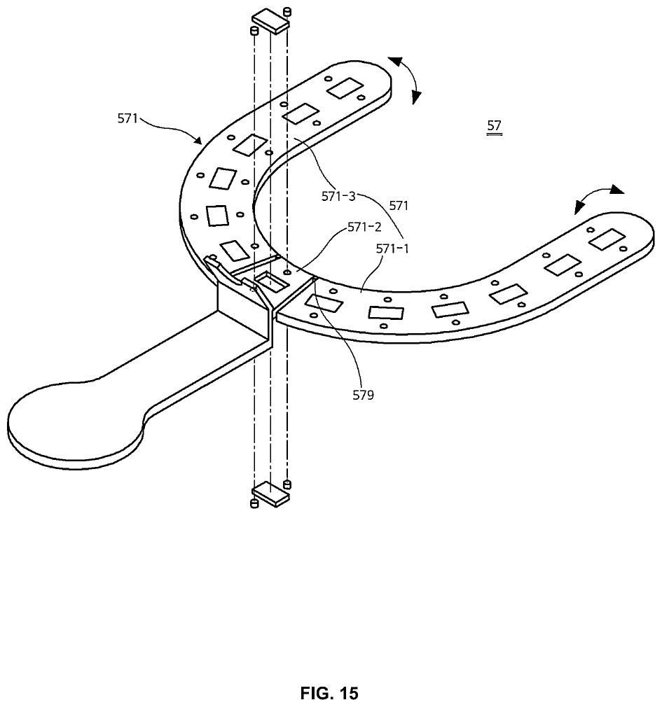

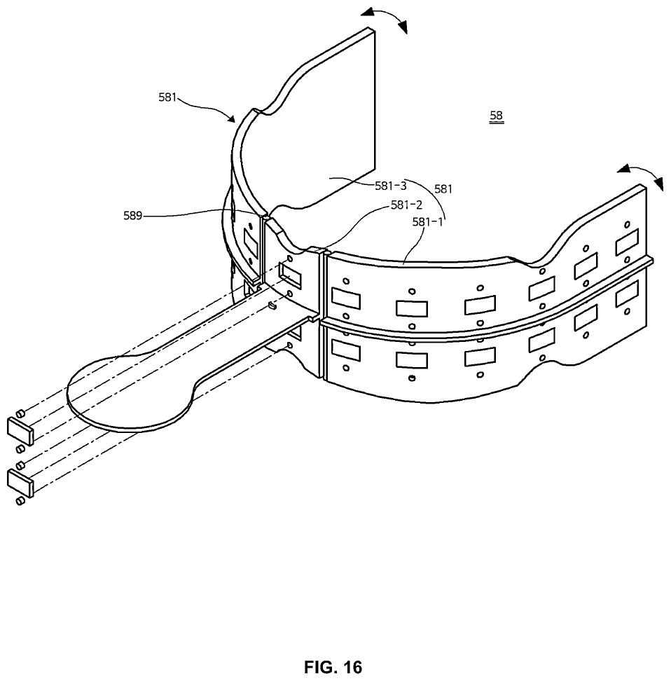

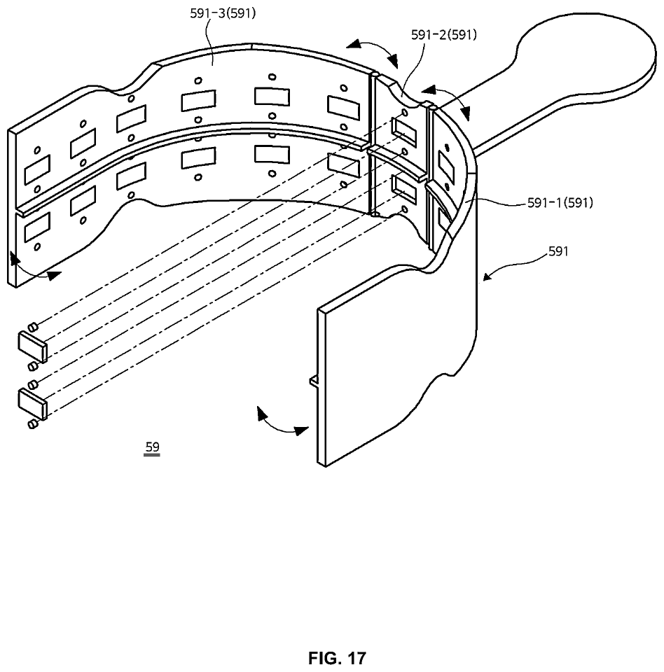

FIG. 15 is a perspective view showing a third embodiment of the occlusal-surface oral imaging device of FIG. 5, FIG. 16 is a perspective view showing a third embodiment of a rear-surface oral imaging device of FIG. 10, and FIG. 17 is a perspective view showing a third embodiment of a front-surface oral imaging device of FIG. 11.

As shown in FIG. 15, in a third occlusal-surface oral imaging device 57 of the present disclosure, a fourth body 571 is coupled by two hinges 579, and when assembled, the device 57 includes fourth sub-bodies 571-1, 571-2, 571-3 constituting the body 511 of FIG. 5 as described above.

Here, the hinge 579 is disposed at a rearmost position among side walls of the sub-bodies adjacent thereto, and disposed in a vertical configuration with respect to an insertion direction of the oral imaging device, thereby allowing both ends of the fourth body 571 to rotate inward.

Meanwhile, as shown in FIG. 16, in a third rear-surface oral imaging device 580 of the present disclosure, a fifth body 581 is coupled by two hinges 589, and when assembled, the device 57 includes fifth sub-bodies 581-1, 581-2, and 581-3 constituting the second body 521 of FIG. 10 as described above.

Here, the hinge 589 is disposed in a vertical configuration along the side walls of the sub-bodies adjacent thereto, thereby allowing both ends of the fifth body 581 to rotate inward.

Meanwhile, as shown in FIG. 14, in a third front-surface oral imaging device 590 of the present disclosure, a sixth body 591 is coupled by two hinges 599, and when assembled, the device 57 includes sixth sub-bodies 591-1, 591-2, and 591-3 constituting the third body 531 of FIG. 11 as described above.

Here, the hinge 599 is disposed in a vertical configuration along the side walls of the sub-bodies adjacent thereto, thereby allowing both ends of the sixth body 591 to rotate inward.

That is, the mouthpiece-type oral imaging device of the present disclosure is configured to be used selectively for an occlusal-surface use, a rear-surface use, and a front-surface use, depending on an area of the teeth to be imaged, and at the same time, the body may be configured with sub-bodies to be rotatably coupled by at least one hinge.

FIG. 18 is a block diagram showing a diagnostic service application in FIG. 3.

The diagnostic service application 9 of FIG. 18 is an application program, software or an application that is installed on the medical staff terminal 7 or the subject terminal 8 to provide dental diagnosis and treatment services to a user in connection with the integrated monitoring/diagnosis server 3.

In addition, as shown in FIG. 18, the diagnostic service application 9 includes a control unit 90, a data transmission and reception unit 91, a data storage unit 92, an operation-mode selection unit 93, an image processing unit 94, a medical staff-mode operation unit 95, and a subject-mode operation unit 97.

The control unit 90 manages and controls the operation of the diagnostic service application 9, and specifically, manages and controls the operations of the control objects 91, 92, 93, 94, 95, 97.

In addition, during execution, the control unit 90 executes the operation-mode selection unit 93, executes the image processing unit 95 when image processing is selected by the user through the operation-mode selection unit 93, executes the medical staff-mode operation unit 97 when a medical staff-mode is selected, and executes the subject-mode operation unit 99 when a subject-mode is selected.

The data transmission and reception unit 91 transmits and receives data to and from the integrated monitoring/diagnosis server 3 and the mouthpiece-type oral imaging device 5 through a communication module (not shown) of the terminal 7 or 8.

In addition, the data transmission and reception unit 91 requests data from the integrated monitoring server 3 and then receives result data in response to the requested data.

The data storage unit 92 stores data in the memory of the terminal under the control of the control unit 90.

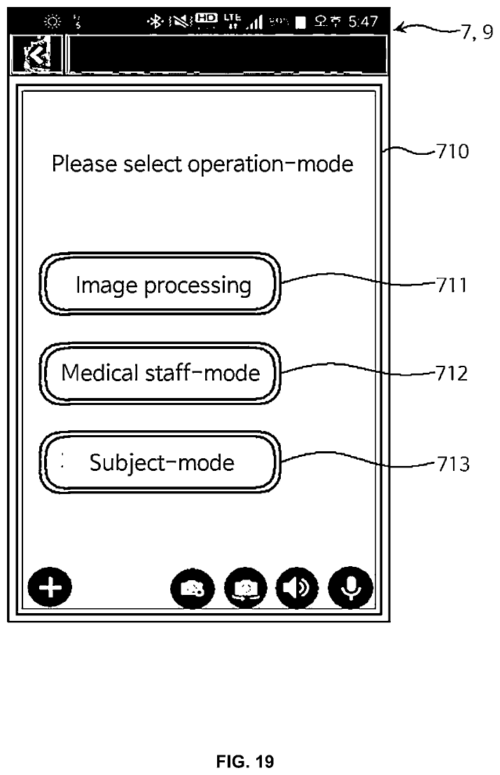

FIG. 19 is an exemplary diagram showing a selection interface provided by an operation-mode selection unit in FIG. 18.

The operation-mode selection unit 93 in FIG. 19 operates when the diagnostic service application 9 is initially executed by the user.

In addition, as shown in FIG. 19, the operation-mode selection unit 93 displays a selection interface 710, which is a graphic user interface (GUI) for allowing the user to select any one of image processing, a medical staff-mode, and a subject-mode on a monitor of the terminal 7 or 8.

Here, a button 711 for selecting image processing, a button 712 for selecting the medical staff-mode, and a button 713 for selecting the subject-mode are shown on the selection interface 710.

In addition, the operation-mode selection unit 93 executes the image processing unit 95 when the image processing button 711 is touched (clicked) by the user, executes the medical staff-mode operation unit 97 when the medical staff-mode button 712 is touched (clicked), and executes the subject-mode operation unit 99 when the subject-mode button 713 is touched (clicked).

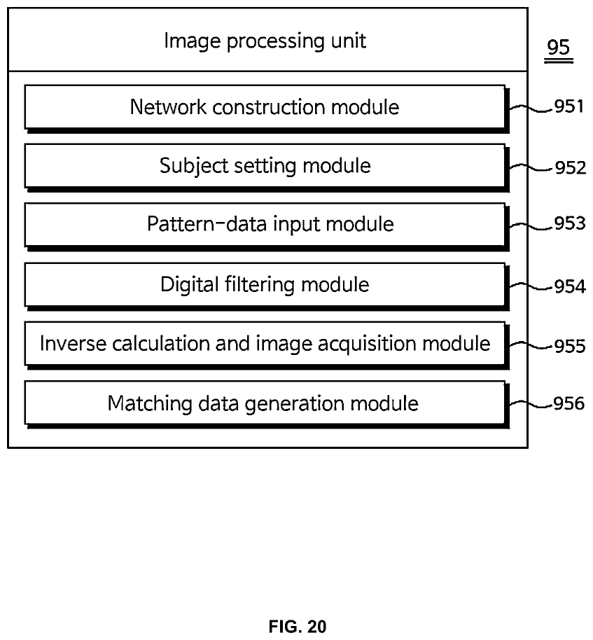

FIG. 20 is a block diagram showing an image processing unit in FIG. 17.

The image processing unit 95 of FIG. 20 is executed under the control of the control unit 90 when the image processing button 711 is touched (clicked) by the user through the selection interface 710 of FIG. 19 as described above.

In addition, as shown in FIG. 20, the image processing unit 95 includes a network construction module 951, a subject setting module 952, a pattern-data input module 953, a digital filtering module 954, an inverse calculation and image acquisition module 955, and a matching data generation module 956.

The network construction module 951 checks whether the mouthpiece-type oral imaging device 5, which will image the subject's teeth, is connected to the wired and wireless communication network 20.

The subject setting module 952 receives identification information of the subject to be imaged from a medical staff.

The pattern-data input module 953 receives pattern-data transmitted from the mouthpiece-type oral imaging device 5 through the data transmission and reception unit 92.

At this time, each pattern-data includes lens-less camera identification information.

The digital filtering module 954 filters reflected signals outside the wavelength pass-band of the pattern-data input through the pattern-data input module 953.

Typically, in the related art, an optical filter that filters light having a specific wavelength is provided to be spaced apart from an outside of a lens camera to implement a quantitative light-induced fluorescence (QLF) (registered trademark) technique, but the physical installation of such an optical filter increases the thickness of a mouthpiece-type product and at the same time requires an increase in the amount of light due to the light transmittance of 20%, so the amount of heat generated also increases in proportion to the increased amount of light, and thus, when applied to a mouthpiece-type product as in the present disclosure, there is a problem of causing safety accidents such as burns.

In the present disclosure, the digital filtering module 954 of the diagnostic service application 9 may convert pattern-data acquired by imaging with the lens-less camera 953 into color values in a wavelength pass-band so as to dramatically solve the problem in the related art, and moreover, through the quantitative light-induced fluorescence technique, a porphyrin component that generate a biofilm in an oral cavity may be displayed in red, and caries lesions, cracks, fluorosis, tartar, and plaque on the tooth surface may be easily identified depending on a difference in brightness of the reflected light.

The inverse calculation and image acquisition module 955 uses a point spread function (PSF) of the phase mask 5131 to inversely calculate the pattern-data of the wavelength pass-band in the digital filtering module 954, and converts the inversely calculated pattern-data into a lens-based image.

Here, the phase mask is configured in a three-dimensional shape structure having a different height for each position according to a phase conversion pattern, and the phase conversion pattern of the phase mask having the three-dimensional shape structure corresponds to a point spread function (PSF) having a two-dimensional pattern.

In addition, an inverse calculation function applied to the inverse calculation and image acquisition module 955 may be preset and stored as a value corresponding to the point spread function (PSF) of the corresponding phase mask.

The matching data generation module 956 matches subject identification information, medical staff identification information, imaging direction (occlusal surface, front surface, rear surface, or the like) information, lens-less camera identification information, and images using the identification information of the mouthpiece-type oral imaging device 5 and the identification information of each lens-less camera 513 to generate matching data.

Here, when matching data is generated by the matching data generation module 956, the control unit 90 controls the data transmission and reception unit 92 to transmit the generated matching data to the integrated monitoring/diagnosis server 3.

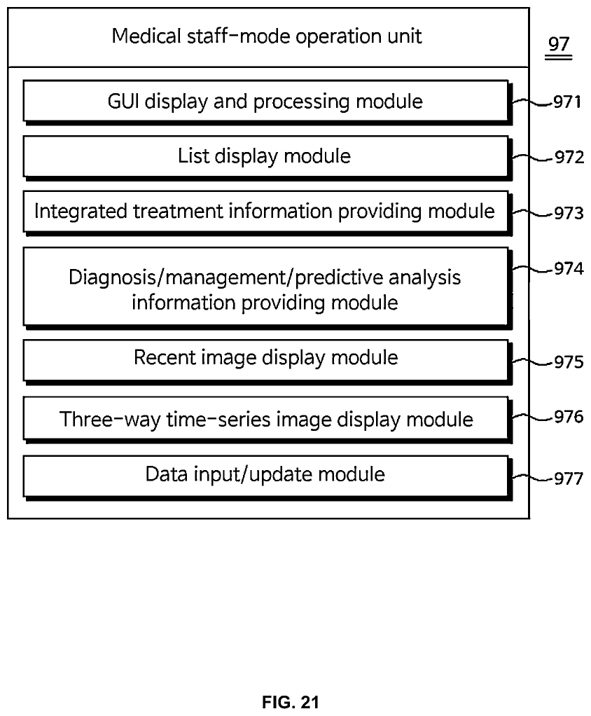

FIG. 21 is a block diagram showing a medical staff-mode operation unit in FIG. 18.

The medical staff-mode operating unit 97 of FIG. 21 is executed under the control of the control unit 90 when the medical staff-mode button 712 is touched (clicked) by the user through the selection interface 710 of FIG. 19 as described above, and the connected medical staff is authenticated through login authentication to perform an operation when the authentication is successful.

In addition, as shown in FIG. 21, the medical staff-mode operation unit 97 includes a GUI display and processing module 971, a list display module 972, an integrated treatment information providing module 973, a diagnosis/management/predictive analysis information providing module 974, a recent image display module 975, and a three-way time-series image display module 976.

The GUI display and processing module 971 displays pre-made GUIs on the monitor of the terminal 7 or 8, and at the same time, executes, when a command is requested from a medical staff (user) through the displayed GUI, a processor corresponding thereto to perform calculations, and then provides a GUI with exposed response data to the medical staff through the GUI corresponding to the response data.

The list display module 972 displays a GUI that exposes a list of subjects received from the integrated monitoring/diagnosis server 3 on the monitor of the terminal 7 or 8 at the request of the medical staff.

The integrated treatment information providing module 973 refers to and utilizes, when receiving a request for integrated treatment information of a specific subject from the medical staff, the integrated treatment information of all subjects received from the integrated monitoring/diagnosis server 3 to extract the integrated treatment information of the selected subject, and then display it on the monitor of the terminal 7 or 8 through the GUI.

Here, the integrated treatment information includes the subject's personal information, diagnosis date and history, treatment date and history, diagnostic analysis information, management analysis information, predictive analysis information, and the like, wherein the diagnostic analysis information refers to the diagnosis of a current tooth condition detected by the integrated monitoring/diagnosis server 3 through the AI analysis of the subject's tooth image, the management analysis information refers to the management status and improvement point detected by the integrated monitoring/diagnosis server 3 through the AI analysis of the subject's tooth image, and the predictive analysis information refers to the prediction of a future tooth condition detected by the integrated monitoring/diagnosis server 3 through the AI analysis of the subject's tooth image.

The diagnosis/management/predictive analysis information providing module 974 extracts, when receiving a request from a medical staff for diagnostic analysis information, management analysis information, or predictive analysis information of a specific subject, the diagnostic analysis information, management analysis information, or predictive analysis information from the subject's integrated treatment information, and then displays the extracted information on the monitor of the terminal 7 or 8 through the GUI.

That is, medical staff may view and recognize an AI analysis result of each subject's tooth image through the GUI provided through the diagnosis/management/predictive analysis information providing module 974.

The recent image display module 975 refers to and utilizes, when receiving a request from a medical staff for a recent tooth image of a specific subject, the tooth-image data of all subjects received from the integrated monitoring/diagnosis server 3 to extract three-way images for each tooth that have been recently imaged by the selected subject, then generates a GUI that displays the extracted three-way images for each tooth, and displays the generated GUI on the monitor of the terminal 7 or 8.

The three-way time-series image display module 976 generates, when receiving a request for a time-series image of a specific tooth from a medical staff, a GUI on which images for each direction (front, rear, occlusal surfaces, etc.) of the tooth are listed and displayed in a time series, and then displays the generated GUI on the monitor of the terminal 7 or 8.

Describing the medical staff-mode operation unit 99 with reference again to FIG. 18, the medical staff-mode operation unit 99 is executed under the control of the control unit 90 when the subject-mode button 713 is touched (clicked) by the user through the selection interface 710 of FIG. 19 as described above, and the connected subject is authenticated through login authentication to perform an operation when the authentication is successful.

In addition, the subject-mode operation unit 99 includes the GUI display and processing module 971, the integrated treatment information providing module 973, the diagnosis/management/predictive analysis information providing module 974, the recent image display module 975, and the three-way time-series image display module 976 in FIG. 21 as described above, but only data access to the subject himself or herself is permitted.

That is, the subject-mode operation unit 99 of the diagnostic service application 9 may provide the subject with integrated treatment information, dental images, and diagnosis/management/predictive analysis information for himself or herself, thereby allowing the subject to quickly and accurately view his or her own diagnosis and treatment status.

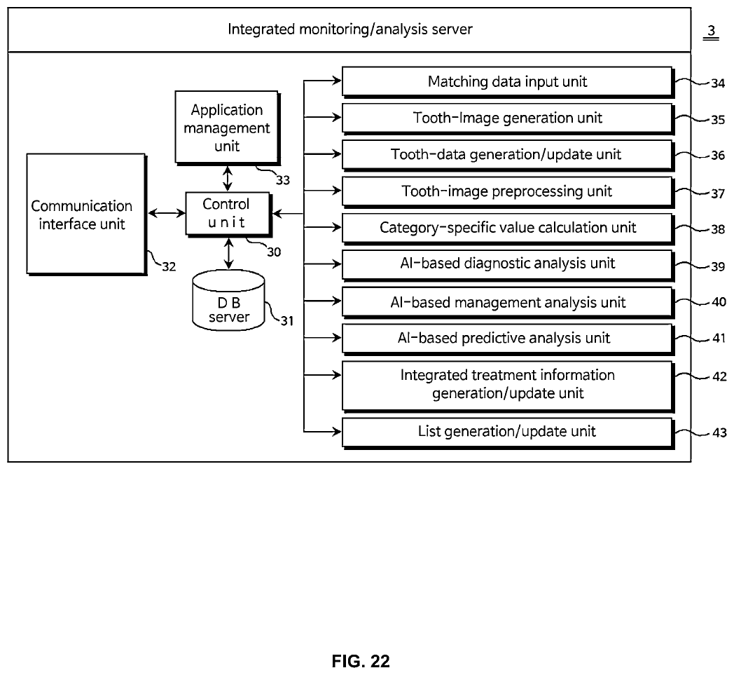

FIG. 22 is a block diagram showing an integrated monitoring/diagnosis server in FIG. 3.

As shown in FIG. 22, the integrated monitoring/diagnosis server 3 includes a control unit 30, a DB server 31, a communication interface unit 32, an application management unit 33, a matching data input unit 34, a tooth-Image generation unit 35, a tooth-data generation/update unit 36, a tooth-image preprocessing unit 37, a category-specific value calculation unit 38, an AI-based diagnostic analysis unit 39, an AI-based management analysis unit 40, an AI-based predictive analysis unit 41, an integrated treatment information generation/update unit 42, and a list generation/update unit 43.

The control unit 30, which is an operating system (OS) of the integrated monitoring/diagnosis server 3, manages and controls the operations of control objects 31, 32, 33, 34, 35, 36, 37, 38, 39, 40, 41, 42, 43.

In addition, when matching data is received from the diagnostic service application 9 through the communication interface unit 32, the control unit 30 stores the received matching data in the DB server 31 and at the same time outputs it to the matching data input unit 34.

In addition, when integrated treatment information is generated/updated in the integrated treatment information generation/update unit 42, the control unit 30 stores the generated/updated integrated treatment information in the DB server 31.

Additionally, when list information is generated/updated in the list generation/update unit 43, the control unit 30 stores the generated/updated list information in the DB server 31 and at the same time transmits it to the connected diagnostic service application 9.

The personal information and login information of pre-registered medical staffs, and the personal information and login information of pre-registered subjects are stored in the DB server 31.

In addition, matching data received from the diagnostic service application 9 is stored in the DB server 31.

Additionally, tooth-images generated in the tooth-image generation unit 35 and tooth-data generated/updated in the tooth-data generation/update unit 36 are stored in the DB server 31.

Here, the tooth-image refers to an image of a single tooth, and the tooth-data refers to data in which the tooth-image, subject identification information, and tooth identification number are matched.

In addition, a value (M) for each category of each tooth calculated by the category-specific value calculation unit 38 is stored in the DB server 31.

Here, the category may include caries lesions, cracks, fluorosis, tartar, plaque, and the like, and the value (M) for each category refers to a value indicating a degree of the corresponding category.

In addition, diagnostic analysis information generated by the AI-based diagnostic analysis unit 39, management analysis information generated by the AI-based management analysis unit 40, and predictive analysis information generated by the AI-based predictive analysis unit 41 are stored in the DB server 31.

Additionally, integrated treatment information generated/updated by the integrated treatment information generation/update unit 42 and list information generated/updated by the list generation/update unit 43 are stored in the DB server 31.

The communication interface unit 32 transmits and receives data to and from the diagnostic service application 9.

The application management unit 33 manages an overall operation of the diagnostic service application 9, such as firmware update, GUI update, failures and errors, and the like.

The matching data input unit 34 receives matching data transmitted from the diagnostic service application 9.

Here, the matching data includes subject identification information, medical staff identification information, imaging direction (occlusal surface, front surface, rear surface, or the like) information, lens-less camera identification information, and images.

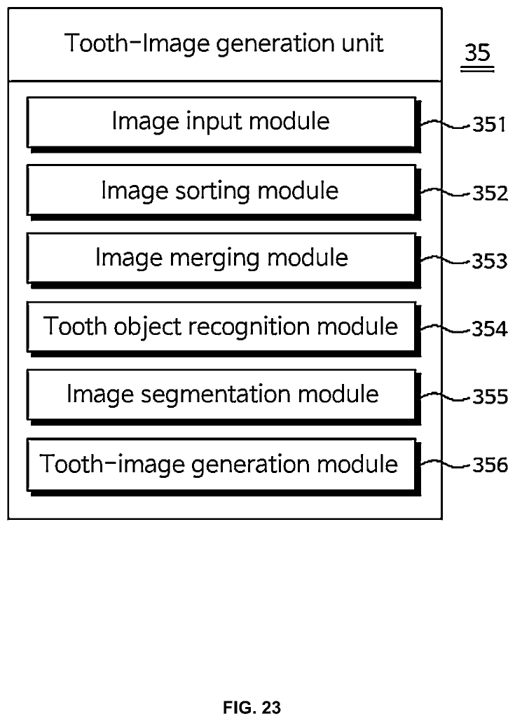

FIG. 23 is a block diagram showing a tooth-image generation unit in FIG. 22.

The tooth-image generation unit 35 of FIG. 23 is a processor that analyzes, corrects, and merges images included in the matching data received through the matching data input unit 34 to generate a tooth-image, which is an image for each tooth.

Here, the mouthpiece-type oral imaging device 5 of FIGS. 5 to 17 as described above is provided with lens-less cameras 513 in consideration of the average number, size, position, and spacing of teeth, but due to the oral characteristics of the subject, a phenomenon in which a single tooth is divided into adjacent images or two or more teeth are imaged in a single image frequently occurs.

That is, the tooth-image generation unit 35 of the present disclosure converts images captured by the lens-less camera 513 into tooth-images for respective teeth, thereby accurately performing an analysis for tooth diagnosis and treatment.

In addition, as shown in FIG. 23, the tooth-image generation unit 35 includes an image input module 351, an image sorting module 352, an image merging module 353, a tooth object recognition module 354, an image segmentation module 355, and a tooth-image generation module 356.

The image input module 351 receives images included in matching data input through the matching data input module 34.

The image sorting module 352 sorts the images in order according to the dentition with reference to the identification information of the lens-less camera 513.

The image merging module 353 merges the images sorted in the image sorting module 352.

The tooth object recognition module 354 analyzes the image merged by the image merging module 353 to recognize tooth objects, respectively, using a preset object recognition algorithm.

Here, the technology and method for recognizing a previously set object from an image is a widely known technology and method in image analysis, and thus a detailed description thereof will be omitted.

The image segmentation module 355 segments the merged image into images in which tooth objects recognized by the tooth object recognition module 354 are shown.

The tooth-image generation module 356 determines the images segmented by the image segmentation module 355 as tooth-images, respectively.

If the subject is imaged for the first time, the tooth-data generation/update unit 36 assigns an identification number to a tooth corresponding to a tooth-image generated by the tooth-image generation unit 35, and then matches subject identification information, an imaging direction (occlusal, front or rear surfaces), a tooth identification number and a tooth-image, an imaging date, and the like to generate tooth-data, and then stores the generated tooth-data in the DB server 31.

In addition, if the subject is not imaged for the first time, the tooth-data generation/update unit 36 extracts the subject's tooth-data from the DB server 31, and then matches an identification number with a tooth corresponding to a tooth-image generated by the tooth-image generation unit 35 with reference to a tooth identification number of previous tooth-data, and adds an imaging direction (occlusal, front or rear surfaces), a tooth identification number and a tooth-image, an imaging date, and the like to update tooth-data, and then stores the updated tooth-data in the DB server 31.

The tooth-image preprocessing unit 37 preprocesses each tooth-image such that a value for each category can be accurately detected from each tooth-image generated by the tooth-image generation unit 35.

The category-specific value calculation unit 38 analyzes each tooth-image preprocessed in the tooth-image preprocessing unit 37 using a preset category detection algorithm to calculate a value (M) for each category of each tooth.

Here, the category may include caries lesions, cracks, fluorosis, tartar, plaque, and the like, and the value (M) for each category refers to a value indicating a degree of the corresponding category.

For example, when the category is ‘tartar’, the category-specific value calculation unit 38 may calculate a tartar value (M), which is a degree of tartar on each tooth, and when the category is ‘caries lesion’, the category-specific value calculation unit 38 may calculate a caries-lesion value (M), which is a degree of caries lesions on each tooth.

In addition, when the value (M) for each category of each tooth is calculated, the category-specific value calculation unit 38 matches the subject identification information with the values (M) for each category of each tooth to generate category information for each tooth, and then store the generated category information in the DB server 31.

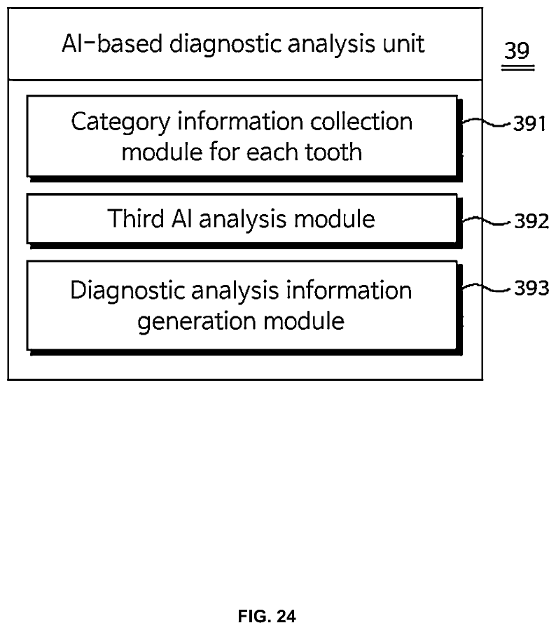

FIG. 24 is a block diagram showing an AI-based diagnostic analysis unit in FIG. 22.

The AI-based diagnostic analysis unit 39 in FIG. 24 analyzes category information (including values (M) for each category) for each tooth using a pre-trained first AI algorithm to generate diagnostic analysis information including a tooth condition, a treatment status, treatment details, and the like of each tooth.

In addition, as shown in FIG. 24, the AI-based diagnostic analysis unit 39 includes a category information collection module 391 for each tooth, a third AI analysis module 392, and a diagnostic analysis information generation module 393.

The category information collection module 391 for each tooth collects category information for each tooth calculated by the category-specific value calculation unit 38 and previous category information for each tooth stored in the DB server 31.

The first AI analysis module 392 analyzes the category information for each tooth collected by the category information collection module for each tooth 391 using a pre-trained second AI algorithm.

Here, the first AI algorithm performs training in a method of generating training data that can train a correlation among a current value (M) and a previous value (M′) for each category of each tooth, and a diagnosis result, and deriving an extraction model, which is a set of parameter values for the correlation among a current value (M) and a previous value (M′) for each category of each tooth, and a diagnosis result using the generated training data.

That is, the first AI algorithm is a deep learning algorithm that outputs a management result such as a diagnosis result such as a tooth condition, a treatment status, and treatment details using a current value (M) and a previous value (M′) for each category of each tooth as input data.

The diagnostic analysis information generation module 393 utilizes the output data output from the first AI analysis module 392 to generate diagnostic analysis information including a tooth condition, a treatment status, and treatment details for each tooth.

Here, the diagnostic analysis information generated by the diagnostic analysis information generation module 393 is stored in the DB server 31 and at the same time is output to the integrated treatment information generation/update unit 42.

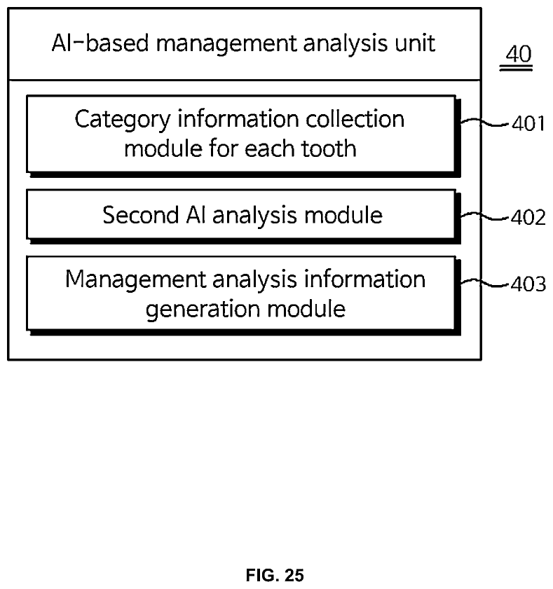

FIG. 25 is a block diagram showing an AI-based management analysis unit in FIG. 22.

The AI-based management analysis unit 40 of FIG. 25 analyzes the category information of each tooth (including values (M) for each category) using a pre-trained second AI algorithm to generate management analysis information including a management status, a management method, a management improvement point, and the like of each tooth.

In addition, as shown in FIG. 25, the AI-based management analysis unit 40 includes a category information collection module 401 for each tooth, a second AI analysis module 402, and a management analysis information generation module 403.

As described above, the category information collection module 401 for each tooth collects a current value (M) and a previous value (M′) for each category of each tooth.

The second AI analysis module 402 analyzes the category information for each tooth collected by the category information collection module for each tooth 401 using a pre-trained second AI algorithm.

Here, the second AI algorithm performs training in a method of generating training data that can train a correlation among a current value (M) and a previous value (M′) for each category of each tooth, and a management result (a management status, a management method, a management improvement point, etc.), and deriving an extraction model, which is a set of parameter values for the correlation among a current value (M) and a previous value (M′) for each category of each tooth, and a management result using the generated training data.

That is, the second AI algorithm is a deep learning algorithm that outputs a management result such as a management status, a management method, and a management improvement point using a current value (M) and a previous value (M′) for each category of each tooth as input data.

The management analysis information generation module 403 utilizes the output data output from the second AI analysis module 402 to generate management analysis information including a management status, a management method, and a management improvement point for each tooth.

Here, the management analysis information generated by the management analysis information generation module 403 is stored in the DB server 31 and at the same time is output to the integrated treatment information generation/update unit 42.

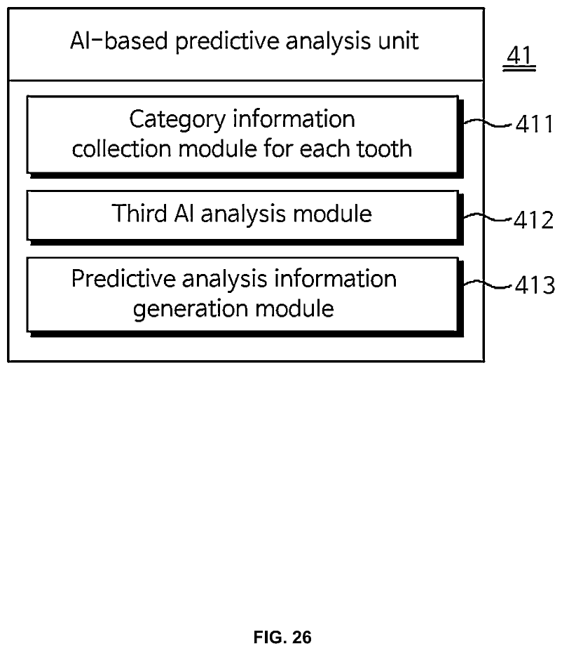

FIG. 26 is a block diagram showing an AI-based predictive analysis unit in FIG. 22.

The AI-based predictive analysis unit 41 in FIG. 26 uses a pre-trained third AI algorithm to analyze category information (including values (M) for each category) of each tooth, and generates, when each tooth is not treated, predictive analysis information including a tooth condition after a preset elapsed time.

In addition, as shown in FIG. 26, the AI-based predictive analysis unit 41 includes a category information collection module 411 for each tooth, a third AI analysis module 412, and a predictive analysis information generation module 413.

As described above, the category information collection module 411 for each tooth collects a current value (M) and a previous value (M′) for each category of each tooth.

The third AI analysis module 412 analyzes the category information for each tooth collected by the category information collection module for each tooth 411 using a pre-trained second AI algorithm.

Here, the third AI algorithm performs training in a method of generating training data that can train a correlation among a current value (M) and a previous value (M′) for each category of each tooth, and a prediction result (a tooth condition after a preset elapsed time when each tooth is not treated), and deriving an extraction model, which is a set of parameter values for the correlation among a current value (M) and a previous value (M′) for each category of each tooth, and a prediction result using the generated training data.

That is, the third AI algorithm is a deep learning algorithm that outputs a tooth condition after a preset elapsed time using a current value (M) and a previous value (M′) for each category of each tooth as input data when each tooth is not treated.

The predictive analysis information generation module 413 utilizes the output data output from the third AI analysis module 412 to generate predictive analysis information indicating a tooth condition after a preset elapsed time when each tooth is not treated.

Here, the predictive analysis information generated by the management analysis information generation module 413 is stored in the DB server 31 and at the same time is output to the integrated treatment information generation/update unit 42.

If the subject is diagnosed for the first time, the integrated treatment information generation unit 42 provides integrated treatment information by matching subject identification information, identification number of each tooth, a tooth-image for each direction of each tooth, a value (M) for each category of each tooth, diagnostic analysis information, management analysis information, and predictive analysis information.

In addition, if the subject is not diagnosed for the first time, the integrated treatment information generation unit 42 extracts the subject's previous integrated treatment information, and then adds a tooth-image for each direction of each tooth, a value (M) for each category of each tooth, diagnostic analysis information, management analysis information, and predictive analysis information to the extracted integrated treatment information to update the integrated treatment information.

The list generation/update unit 43 generates and updates list information indicating a list of patients for whom imaging and diagnosis have been carried out.

What is claimed is:

1. A dental diagnosis and management system, the system comprising:
a mouthpiece-type oral imaging device comprising a body inserted into a subject's oral cavity, lens-less cameras provided at intervals on the body to capture at least one of the front, rear, and occlusal surfaces of all teeth, and light sources provided at positions adjacent to the lens-less cameras, respectively, to irradiate light;
a medical staff terminal, which is a terminal carried by a medical staff member, provided with a diagnostic service application that digitally filters pattern-data received from the mouthpiece-type oral imaging device to a preset wavelength pass-band, and then performs inverse calculations to acquire an image; and
an integrated monitoring/diagnosis server that analyzes images received from the medical staff terminal, detects a diagnostic result including at least one of a condition of each tooth of the subject, a treatment status, and a treatment details, and then generates diagnostic analysis information including the detected diagnostic result to transmit the generated diagnostic analysis information to the medical staff terminal,
wherein the diagnostic service application installed on the medical staff terminal displays the diagnostic analysis information received from the integrated monitoring/diagnosis server on a monitor.

2. The system of claim 1, wherein the lens-less cameras each comprises:
a mask through which light reflected from an imaging surface of the tooth is transmitted;
an image sensor into which light passing through the mask is incident; and
a controller that integrates patterns projected onto the image sensor to generate pattern-data, and then transmits the generated pattern-data to the outside,
wherein the body is formed of a plate having a length, disposed with a curved surface in such a manner of facing rearward toward both ends thereof, and disposed in parallel to the imaging surface (front, rear, or occlusal surface) of the subject's tooth, and
wherein the lens-less cameras slim down the thickness of the mouthpiece-type oral imaging device by replacing the lens with the film-type mask.

3. The system of claim 2, wherein the diagnostic service application installed on the medical staff terminal includes an image processing unit, and
wherein the image processing unit comprises:
a network construction module that checks whether the mouthpiece-type oral imaging device is connected in a wired or wireless manner;
a subject setting module that receives identification information of the subject to be imaged from the medical staff (user);
a pattern-data input module that receives pattern-data transmitted from the mouthpiece-type oral imaging device;
a digital filtering module that filters reflected signals outside the wavelength pass-band of the pattern-data received through the pattern-data input module;
an inverse calculation and image acquisition module that inversely calculates the pattern-data filtered by the digital filtering module to convert the inversely calculated pattern-data into a lens-based image;
a matching data generation module that generates matching data by matching subject identification information, medical staff identification information, tooth imaging direction (occlusal, front or rear surface) information, lens-less camera identification information, and images; and
a control unit that transmits the matching data generated by the matching data generation module to the integrated monitoring/diagnosis server.

4. The system of claim 3, wherein the integrated monitoring/diagnosis server comprises:
a DB server;
a tooth-image generation unit that analyzes, corrects, and merges images included in the matching data received from the medical staff terminal to generate a tooth-image, which is an image for each tooth; and
an AI-based diagnostic analysis unit that analyzes teeth-images of the subject generated by the tooth-image generation unit to generate the diagnostic analysis result, and
wherein the tooth-image generation unit comprises:
an image sorting module that sorts the images included in the matching data received through the matching data input module in order according to the dentition, with reference to the identification information of the lens-less cameras;
an image merging module that merges images sorted in the image sorting module;
a tooth object recognition module that recognizes tooth objects, respectively, by analyzing the merged image in the image merging module using a preset object recognition algorithm;
an image segmentation module that segments the merged image into images in which the tooth objects recognized by the tooth object recognition module are respectively shown; and
a tooth-image generation module that determines the images segmented by the image segmentation module as tooth-images, respectively.

5. The system of claim 4, wherein the integrated monitoring/diagnosis server further comprises a tooth-data generation/update unit that assigns, if the subject is imaged for the first time, an identification number to a tooth corresponding to a tooth-image generated by the tooth-image generation unit, and then matches at least one of subject identification information, a tooth imaging direction (occlusal, front or rear surface), a tooth identification number and a tooth-image, and an imaging date to generate tooth-data, and then stores the generated tooth-data in the DB server, and extracts, if the subject is not imaged for the first time, the subject's tooth-data from the DB server, and then matches an identification number with a tooth corresponding to a tooth-image generated by the tooth-image generation unit with reference to a tooth identification number of previous tooth-data, and then generates tooth-data, and then stores the generated tooth-data in the DB server.

6. The system of claim 5, wherein a category detection algorithm that analyzes the received tooth-image to detect a value (M) for each category (including at least one of caries lesions, cracks, fluorosis, tartar, and plaque) is stored in the DB server, and
wherein the integrated monitoring/diagnosis server further comprises a category-specific value calculation unit that analyzes tooth-images generated by the tooth-image generation unit using the category detection algorithm to calculate a value (M) for each category of each tooth, matches the subject identification information with values (M) for each category of each tooth to generate category information for each tooth, and then stores the generated category information in the DB server.

7. The system of claim 6, wherein a first AI algorithm that uses a current value (M) and a previous value (M′) for each category of each tooth as input data to output a diagnostic result including at least one of a tooth condition, a treatment status, and treatment details is stored in the DB server, and
wherein the AI-based diagnostic analysis unit comprises:
a category information collection module for each tooth that collects category information for each tooth calculated by the category-specific value calculation unit and previous category information for each tooth stored in the DB server;
a first AI analysis that analyzes a current value (M) and previous values (M′) for each category of each tooth collected from the category information collection module for each tooth using the first AI algorithm to output the diagnosis result; and
a diagnostic analysis information generation module that utilizes output data output from the first AI analysis module to generate diagnostic analysis information including the diagnostic result, and then stores the generated diagnostic analysis information in the DB server.

8. The system of claim 6, wherein the integrated monitoring/diagnosis server further comprises:
an AI-based management analysis unit; and
an AI-based predictive analysis unit,
wherein a second AI algorithm that uses a current value (M) and a previous value (M′) for each category of each tooth as input data to output a management result including at least one of a management status, a management method, and a management improvement point, and a third AI algorithm that uses a current value (M) and a previous value (M′) for each category of each tooth as input data to output a prediction result indicating a tooth condition after a preset elapsed time when each tooth is not treated,
wherein the AI-based management analysis unit analyzes a current value (M) and previous values (M′) for each category of each tooth collected from the category information collection module for each tooth using the second AI algorithm to output the management result, and then generates management analysis information including the output management result, and
wherein the AI-based predictive analysis unit analyzes a current value (M) and previous values (M′) for each category of each tooth collected from the category information collection module for each tooth using the third AI algorithm to output the prediction result, and then generates predictive analysis information including the output prediction result.

9. The system of claim 2, wherein in the mouthpiece-type oral imaging device, sensor seating grooves that are disposed inward on a mounting surface, which is one surface of the body opposite to an imaging surface of the subject's teeth, and provided with the lens-less cameras are respectively disposed at intervals in a length direction, and
wherein pairs of light source mounting grooves are disposed at points adjacent to the respective sensor seating grooves on the mounting surface.

10. The system of claim 9, wherein the mouthpiece-type oral imaging device operates in a fluorescence imaging mode, a normal imaging mode, and a mixed imaging mode, and
wherein the light sources irradiate blue-series visible light having a wavelength of 405 nm in the fluorescence imaging mode, irradiate white visible light in the normal imaging mode, and irradiate blue-series visible light having a wavelength of 405 nm from a half of a total number of the light sources, and irradiate white visible light from the remaining light sources in the mixed imaging mode.

11. The system of claim 10, wherein when a mouthpiece-type oral imaging device for imaging the occlusal surfaces of a subject's upper teeth and the occlusal surfaces of the subject's lower teeth is referred to as an occlusal-surface oral imaging device, the body of the occlusal-surface oral imaging device is disposed horizontally such that an upper surface of the body is in contact with the occlusal surfaces of the subject's upper teeth, a lower surface of the body is in contact with the occlusal surfaces of the subject's lower teeth, and the sensor seating grooves are disposed at intervals in a length direction on the upper and lower surfaces of the body.

12. The system of claim 11, wherein the body is formed of a plate and coupled by at least one hinge shaft, and comprises at least two or more sub-bodies constituting the body during the coupling of a hinge,
wherein the sensor seating grooves and the light source mounting grooves are disposed on upper and lower surfaces of the sub-bodies, and
wherein the hinge shaft is connected to opposing side walls of sub-bodies adjacent thereto, respectively, and installed in a vertical configuration such that the body rotates inward when the sub-bodies are assembled.

13. The system of claim 12, wherein the sub-bodies are arranged in the same number as that of the lens-less cameras in a length direction, and
wherein single sensor seating grooves are disposed on the upper and lower surfaces of the sub-bodies, respectively.

14. The system of claim 10, wherein when a mouthpiece-type oral imaging device for imaging the front surfaces of a subject's upper and lower teeth is referred to as a front-surface oral imaging device, the body of the front-surface oral imaging device is disposed vertically such that a rear surface of the body faces the front surfaces of the subject's teeth, and the sensor seating grooves are disposed at intervals in a length direction on the rear surface of the body, and arranged in two rows.

15. The system of claim 14, wherein the body is formed of a plate and coupled by at least one hinge shaft, and comprises at least two or more sub-bodies constituting the body during the coupling of a hinge,
wherein the sensor seating grooves and the light source mounting grooves are disposed on rear surfaces of the sub-bodies, and
wherein the hinge shaft is connected to opposing side walls of sub-bodies adjacent thereto, respectively, and installed in a vertical configuration such that the body rotates inward when the sub-bodies are assembled.

16. The system of claim 15, wherein the sub-bodies are arranged in the same number as that of the lens-less cameras in a length direction, and wherein pairs of lens-less cameras are provided on rear surfaces of the sub-bodies, respectively, at intervals in a height direction.

17. The system of claim 10, wherein when a mouthpiece-type oral imaging device for imaging the rear surfaces of a subject's upper and lower teeth is referred to as a rear-surface oral imaging device, the body of the rear-surface oral imaging device is disposed vertically such that a front surface of the body faces the rear surfaces of the subject's teeth, and the sensor seating grooves are disposed at intervals in a length direction on the front surface of the body, and arranged in two rows.

18. The system of claim 17, wherein the body is formed of a plate and coupled by at least one hinge shaft, and comprises at least two or more sub-bodies constituting the body during the coupling of a hinge,
wherein the sensor seating grooves and the light source mounting grooves are disposed on front surfaces of the sub-bodies, and
wherein the hinge shaft is connected to opposing side walls of sub-bodies adjacent thereto, respectively, and installed in a vertical configuration such that the body rotates inward when the sub-bodies are assembled.

19. The system of claim 18, wherein the sub-bodies are arranged in the same number as that of the lens-less cameras in a length direction, and
wherein pairs of lens-less cameras are provided on front surfaces of the sub-bodies, respectively, at intervals in a height direction.
